(19) United States
(12) Patent Application Publication
(10) Pub. No.: US 2024/0312069 A1
(43) Pub. Date: Sep. 19, 2024

(54) IMAGE COMPRESSION AND DECODING, VIDEO COMPRESSION AND DECODING: TRAINING METHODS AND TRAINING SYSTEMS

(71) Applicant: DEEP RENDER LTD, London (GB)

(72) Inventors: Chri BESENBRUCH, London (GB); Ciro CURSIO, London (GB); Christopher FINLAY, London (GB); Vira KOSHKINA, London (GB); Alexander LYTCHIER, London (GB); Jan XU, London (GB); Arsalan ZAFAR, London (GB)

(21) Appl. No.: 18/409,034

(22) Filed: Jan. 10, 2024

Related U.S. Application Data
(63) Continuation of application No. 18/099,444, filed on Jan. 20, 2023, now Pat. No. 11,881,003.
Application No. 18/099,444 is a continuation of application No. PCT/GB2021/051858, filed on Jul. 20, 2021.
Application No. PCT/GB2021/051858 is a continuation of application No. PCT/GB2021/051041, filed on Apr. 29, 2021.
(60) Provisional application No. 63/053,807, filed on Jul. 20, 2020.

(30) Foreign Application Priority Data
Jul. 20, 2020 (GB) 2011176.1
Aug. 11, 2020 (GB) 2012461.6
Aug. 11, 2020 (GB) 2012462.4
Aug. 11, 2020 (GB) 2012463.2
Aug. 11, 2020 (GB) 2012465.7
Aug. 11, 2020 (GB) 2012467.3
Aug. 11, 2020 (GB) 2012468.1
Aug. 11, 2020 (GB) 2012469.9
Oct. 23, 2020 (GB) 2016824.1
Dec. 10, 2020 (GB) 2019531.9

(51) Int. Cl. G06T 9/00; G06N 3/084

(52) U.S. Cl. CPC G06T 9/002; G06N 3/084

(57) ABSTRACT

A computer-implemented method of training an image generative network f_{θ} for a set of training images, in which an output image \hat{x} is generated from an input image x of the set of training images non-losslessly, and in which a proxy network is trained for a gradient intractable perceptual metric that evaluates a quality of an output image \hat{x} given an input image x, the method of training using a plurality of scales for input images from the set of training images. In an embodiment, a blindspot network b_{α} is trained which generates an output image \tilde{x} from an input image x. Related computer systems, computer program products and computer-implemented methods of training are disclosed.

### CROSS-REFERENCE TO RELATED APPLICATIONS

This application is a continuation of U.S. application Ser. No. 18/099,444, filed on Jan. 20, 2023, which is a bypass continuation of International Application No. PCT/GB2021/051858, filed on Jul. 20, 2021, which claims priority to GB Application No. GB2011176.1, filed on Jul. 20, 2020; U.S. Application No. 63/053,807, filed on Jul. 20, 2020; GB Application No. GB2012461.6, filed on Aug. 11, 2020; GB Application No. 2012462.4, filed on Aug. 11, 2020; GB Application No. 2012163.2, filed on Aug. 11, 2020; GB Application No. 2012465.7, filed on Aug. 11, 2020; GB Application No. GB2012467.3, filed on Aug. 11, 2020; GB Application No. 2012468.1, filed on Aug. 11, 2020; GB Application No. GB2012469.9, filed on Aug. 11, 2020; GB Application No. GB2016824.1, filed on Oct. 23, 2020; GB Application No. GB2019531.9, filed on Dec. 10, 2020; and International Application No. PCT/GB2021/051041, filed on Apr. 29, 2021, the entire contents of which being fully incorporated herein by reference.

### BACKGROUND OF THE INVENTION

### 1. Field of the Invention

The field of the invention relates to computer-implemented training methods and training systems for an image generative network, e.g. one for image compression and decoding, and to related computer-implemented methods and systems for image generation, e.g. image compression and decoding, and to related computer-implemented methods and systems for video generation, e.g. video compression and decoding.

### 2. Technical Background

There is increasing demand from users of communications networks for images and video content. Demand is increasing not just for the number of images viewed, and for the playing time of video; demand is also increasing for higher resolution, lower distortion content, if it can be provided.

When images are compressed at a source device in a lossy way, this can lead to distortions or artifacts when the images are decompressed at a recipient device. It is desirable to train image encoders and decoders so that distortions or artifacts are minimized when the images are decompressed.

### 3. Discussion of Related Art

U.S. Pat. No. 10,373,300B1 discloses a system and method for lossy image and video compression and transmission that utilizes a neural network as a function to map a known noise image to a desired or target image, allowing the transfer only of hyperparameters of the function instead of a compressed version of the image itself. This allows the recreation of a high-quality approximation of the desired image by any system receiving the hyperparameters, provided that the receiving system possesses the same noise image and a similar neural network. The amount of data required to transfer an image of a given quality is dramatically reduced versus existing image compression technology. Being that video is simply a series of images, the application of this image compression system and method allows the transfer of video content at rates greater than previous technologies in relation to the same image quality.

U.S. Pat. No. 10,489,936B1 discloses a system and method for lossy image and video compression that utilizes a metanetwork to generate a set of hyperparameters necessary for an image encoding network to reconstruct the desired image from a given noise image.

Application PCT/GB2021/051041, which is incorporated by reference, discloses methods and systems for image compression and decoding, and for video compression and decoding.

### SUMMARY OF THE INVENTION

According to a first aspect of the invention, there is provided a computer-implemented method of training an image generative network f_{θ} for a set of training images, in which an output image \hat{x} is generated from an input image x of the set of training images non-losslessly, and in which a proxy network is trained for a gradient intractable perceptual metric that evaluates a quality of an output image \hat{x} given an input image x, the method of training using a plurality of scales for input images from the set of training images, the method including the steps of;
(i) receiving an input image x of the set of training images and generating one or more images which are derived from x to make a multiscale set of images {xᵢ} which includes x;
(ii) the image generative network f_{θ} generating an output image îᵢ from an input image xᵢ ∈ {xᵢ}, without tracking gradients for f_{θ};
(iii) the proxy network outputting an approximated function output ŷᵢ, using the xᵢ and the \hat{x}ᵢ as inputs;
(iv) the gradient intractable perceptual metric outputting a function output yᵢ, using the xᵢ and the \hat{x}ᵢ as inputs;
(v) evaluating a loss for the proxy network, using the yᵢ and the ŷᵢ as inputs, and including the evaluated loss for the proxy network in a loss array for the proxy network;
(vi) repeating steps (ii) to (v) for all the images xᵢ in the multiscale set of images {xᵢ};
(vii) using backpropagation to compute gradients of parameters of the proxy network with respect to an aggregation of the loss array assembled in executions of step (v);
(viii) optimizing the parameters of the proxy network based on the results of step (vii), to provide an optimized proxy network;
(ix) the image generative network f_{θ} generating an output image ŷᵢ from an input image xᵢ ∈ {xᵢ};
(x) the optimized proxy network outputting an optimized approximated function output ŷᵢ, using the xᵢ and the \hat{x}ᵢ as inputs;
(xi) evaluating a loss for the generative network f_{θ}, using the xᵢ, the \hat{x}ᵢ and the optimized approximated function output ŷᵢ as inputs, and including the evaluated loss for the generative network f_{θ} in a loss array for the generative network f_{θ};
(xii) repeating steps (ix) to (xi) for all the images xᵢ in the multiscale set of images {xᵢ};
(xiii) using backpropagation to compute gradients of parameters of the generative network f_{θ} with respect to an aggregation of the loss array assembled in executions of step (xi);
(xiv) optimizing the parameters of the generative network f_{θ} based on the results of step (xiii), to provide an optimized generative network f_{θ}, and
(xv) repeating steps (i) to (xiv) for each member of the set of training images.

An advantage is that the multiscale set of images provides improved stability during the training. An advantage is that the proxy network is more robust against adversarial samples. An advantage is that the proxy network is more robust against artifact generation. An advantage is that within the field of learned image and video compression the method allows networks to train with non-differentiable perceptual metrics.

The method may be one wherein steps (ii) to (xv) are repeated for the set of training images, to train the generative network f_{θ} and to train the proxy network. An advantage is improved training of the image generative network. An advantage is improved training of the proxy network.

The method may be one including the step (xvi) of storing the parameters of the trained generative network f_{θ} and the parameters of the trained proxy network.

The method may be one wherein the one or more images which are derived from x to make a multiscale set of images {xᵢ} are derived by downsampling. An advantage is improved stability during the training. An advantage is that the proxy network is more robust against adversarial samples. An advantage is that the proxy network is more robust against artifact generation.

The method may be one wherein the image generative network f_{θ} is a neural network.

The method may be one wherein the rate of change of every parameter in the network is computed with respect to its associated loss, and the parameters are updated in such a way that as to either minimise or maximise the associated loss.

The method may be one wherein the proxy network is a neural network.

The method may be one wherein the proxy network is robust against adversarial examples.

The method may be one wherein the gradients of the proxy network are treated as a noisy differentiable relaxation of the intractable gradients of the gradient intractable perceptual metric.

The method may be one wherein when the pre-trained proxy network is frozen, the generative network f_{θ} will learn to produce examples outside of the learnt boundary of the proxy network.

The method may be one wherein a training of ĥ_{ϕ} involves samples of f_{θ}(x) and x, but does not require gradients for \hat{x}.

The method may be one wherein the generative network f_{θ} includes an encoder, which encodes (by performing lossy encoding) an input image x into a bitstream, and includes a decoder, which decodes the bitstream into an output image \hat{x}.

The method may be one wherein the method includes an iteration of a training pass of the generative network, and a training pass of the proxy network. An advantage is improved stability during the training.

The method may be one wherein the generative and proxy networks have separate optimizers. An advantage is improved stability during the training.

The method may be one wherein for the case of proxy network optimization, gradients do not flow through the generative network.

The method may be one wherein the method is used for learned image compression.

The method may be one wherein the number of input and output parameters to the gradient intractable perceptual metric is arbitrary.

The method may be one wherein the gradient intractable perceptual metric is a perceptual loss function.

The method may be one wherein the gradient intractable perceptual metric is VMAF, VIF, DLM or IFC, or a mutual information based estimator.

The method may be one wherein the generative network includes a compression network, wherein a term is added to the total loss of the compression network to stabilise the initial training of the compression network. An advantage is improved stability during the initial training.

The method may be one wherein the generative loss includes a generic distortion loss which includes one or more stabilisation terms. An advantage is improved stability during the training.

The method may be one wherein the stabilisation terms include Mean Squared Error (MSE) or a combination of analytical losses with weighted deep-embeddings of a pre-trained neural network. An advantage is improved stability during the training.

The method may be one wherein a receptive field covers a larger portion of an image for a downsampled input image. An advantage is the method is more robust against adversarial samples. An advantage is the method is more robust against artifact generation.

The method may be one wherein a perceptual quality score is assigned to the image at each scale and is aggregated by an aggregation function. An advantage is improved stability during the training. An advantage is that the proxy network is more robust against adversarial samples. An advantage is that the proxy network is more robust against artifact generation.

The method may be one wherein a user is able to select a number of scales to use in the multiscale set of images. An advantage is the thoroughness of the training is user selectable.

The method may be one wherein the set of images includes a downsampled image that has been downsampled by a factor of two in each dimension.

The method may be one wherein the set of images includes a downsampled image that has been downsampled by a factor of four in each dimension.

The method may be one wherein the mean of the ŷᵢ is used to train the image generative network by attempting to maximise or minimise the mean of the ŷᵢ using stochastic gradient descent. An advantage is improved stability during the training. An advantage is that the proxy network is more robust against adversarial samples. An advantage is that the proxy network is more robust against artifact generation.

The method may be one wherein the predictions yᵢ are used to train the proxy network to force its predictions to be closer to an output of the perceptual metric, using stochastic gradient descent. An advantage is improved stability during the training. An advantage is that the proxy network is more robust against adversarial samples. An advantage is that the proxy network is more robust against artifact generation.

The method may be one wherein for each image x, an RGB image is provided.

According to a second aspect of the invention, there is provided a computer system configured to train an image generative network f_{θ} for a set of training images, in which the system generates an output image \hat{x} from an input image x of the set of training images non-losslessly, and in which a proxy network is trained for a gradient intractable perceptual metric that evaluates a quality of an output image \hat{x} given an input image x, wherein the computer system is configured to;
(i) receive an input image x from the set of training images and generate one or more images which are derived from x to make a multiscale set of images {xᵢ} which includes x;
(ii) use the image generative network f_{θ} to generate an output image ŷᵢ from an input image xᵢ ∈ {xᵢ}, without tracking gradients for f_{θ};
(iii) use the proxy network to output an approximated function output ŷᵢ, using the xᵢ and the \hat{x}ᵢ as inputs;
(iv) use the gradient intractable perceptual metric to output a function output yᵢ, using the xᵢ and the ŷᵢ as inputs;
(v) evaluate a loss for the proxy network, using the yᵢ and the ŷᵢ as inputs, and to include the evaluated loss for the proxy network in a loss array for the proxy network;
(vi) repeat (ii) to (v) for all the images xᵢ in the multiscale set of images {xᵢ};
(vii) use backpropagation to compute gradients of parameters of the proxy network with respect to an aggregation of the loss array assembled in executions of (v);
(viii) optimize the parameters of the proxy network based on the results of (vii), to provide an optimized proxy network;
(ix) use the image generative network f_{θ} to generate an output image ŷᵢ from an input image xᵢ ∈ {xᵢ};
(x) use the optimized proxy network to output an optimized approximated function output ŷᵢ, using the xᵢ and the \hat{x}ᵢ as inputs;
(xi) evaluate a loss for the generative network f_{θ}, using the xᵢ, the \hat{x}ᵢ and the optimized approximated function output Si as inputs, and to include the evaluated loss for the generative network f_{θ} in a loss array for the generative network f_{θ};
(xii) repeat (ix) to (xi) for all the images xᵢ in the multiscale set of images {xᵢ};
(xiii) use backpropagation to compute gradients of parameters of the generative network f_{θ} with respect to an aggregation of the loss array assembled in executions of (xi);
(xiv) optimize the parameters of the generative network f_{θ} based on the results of (xiii), to provide an optimized generative network f_{θ}, and
(xv) repeat (i) to (xiv) for each member of the set of training images.

An advantage is that the multiscale set of images provides improved stability during training by the computer system. An advantage is that the proxy network is more robust against adversarial samples. An advantage is that the proxy network is more robust against artifact generation.

The computer system may be one wherein (ii) to (xv) are repeated for the set of training images, to train the generative network f_{θ} and to train the proxy network.

The computer system may be configured to perform a method of any aspect of the first aspect of the invention.

According to a third aspect of the invention, there is provided a computer program product executable on a processor to train an image generative network f_{θ} for a set of training images, in which an output image \hat{x} is generated from an input image x of the set of training images non-losslessly, and a proxy network is trained for a gradient intractable perceptual metric that evaluates a quality of an output image \hat{x} given an input image x, the computer program product executable to;
(i) receive an input image x of the set of training images and generate one or more images which are derived from x to make a multiscale set of images {xᵢ} which includes x;
(ii) use the image generative network f_{θ} to generate an output image ŷᵢ from an input image xᵢ ∈ {xᵢ}, without tracking gradients for f_{θ};
(iii) use the proxy network to output an approximated function output ŷᵢ, using the xᵢ and the îᵢ as inputs;
(iv) use the gradient intractable perceptual metric to output a function output yᵢ, using the xᵢ and the \hat{x}ᵢ as inputs;
(v) evaluate a loss for the proxy network, using the yᵢ and the ŷᵢ as inputs, and to include the evaluated loss for the proxy network in a loss array for the proxy network;
(vi) repeat (ii) to (v) for all the images xᵢ in the multiscale set of images {xᵢ};
(vii) use backpropagation to compute gradients of parameters of the proxy network with respect to an aggregation of the loss array assembled in executions of (v);
(viii) optimize the parameters of the proxy network based on the results of (vii), to provide an optimized proxy network;
(ix) use the image generative network f_{θ} to generate an output image \hat{x}ᵢ from an input image xᵢ ∈ {xᵢ};
(x) use the optimized proxy network to output an optimized approximated function output ŷᵢ, using the xᵢ and the \hat{x}ᵢ as inputs;
(xi) evaluate a loss for the generative network f_{θ}, using the xᵢ, the \hat{x}ᵢ and the optimized approximated function output ŷᵢ as inputs, and to include the evaluated loss for the generative network f_{θ} in a loss array for the generative network f_{θ};
(xii) repeat (ix) to (xi) for all the images xᵢ in the multiscale set of images {xᵢ};
(xiii) use backpropagation to compute gradients of parameters of the generative network f_{θ} with respect to an aggregation of the loss array assembled in executions of (xi);
(xiv) optimize the parameters of the generative network f_{θ} based on the results of (xiii), to provide an optimized generative network f_{θ}, and
(xv) repeat (i) to (xiv) for each member of the set of training images.

An advantage is that the multiscale set of images provides improved stability during the training. An advantage is that the proxy network is more robust against adversarial samples. An advantage is that the proxy network is more robust against artifact generation.

The computer program product may be one wherein (ii) to (xv) are repeated for the set of training images, to train the generative network f_{θ} and to train the proxy network.

The computer program product may be one executable on the processor to perform a method of any aspect of the first aspect of the invention.

According to a fourth aspect of the invention, there is provided a computer-implemented method of training an image generative network f_{θ} for a set of training images, in which an output image \hat{x} is generated from an input image x of the set of training images non-losslessly, and in which a proxy network is trained for a gradient intractable perceptual metric that evaluates a quality of an output image \hat{x} given an input image x, the method of training using a plurality of scales for input images from the set of training images.

The method may be one including a method of any aspect of the first aspect of the invention.

An advantage is that the multiscale set of images provides improved stability during the training. An advantage is that the proxy network is more robust against adversarial samples. An advantage is that the proxy network is more robust against artifact generation.

According to a fifth aspect of the invention, there is provided a system including a first computer system and a second computer system, the first computer system including a lossy encoder including a first trained neural network, the second computer system including a decoder including a second trained neural network, wherein the second computer system is in communication with the first computer system, the lossy encoder configured to produce a bitstream from an input image: the first computer system configured to transmit the bitstream to the second computer system, wherein the decoder is configured to decode the bitstream to produce an output image: wherein the first computer system in communication with the second computer system comprises a generative network, wherein the generative network is trained using a method according to any aspect of the first aspect of the invention.

An advantage is that the generative network is more robust against artifact generation. An advantage is that the generative network is more robust against adversarial samples.

The system may be one in which the system is for image or video compression, transmission and decoding, wherein
(i) the first computer system is configured to receive an input image;
(ii) the first computer system is configured to encode the input image using the first trained neural network, to produce a latent representation;
(iii) the first computer system is configured to quantize the latent representation to produce a quantized latent;
(iv) the first computer system is configured to entropy encode the quantized latent into a bitstream;
(v) the first computer system is configured to transmit the bitstream to the second computer system;
(vi) the second computer system is configured to entropy decode the bitstream to produce the quantized latent;
(vii) the second computer system is configured to use the second trained neural network to produce an output image from the quantized latent, wherein the output image is an approximation of the input image. Quantizing, entropy encoding and entropy decoding details are provided in PCT/GB2021/051041.

An advantage is that for a fixed file size (“rate”), a reduced output image distortion is obtained.

The system may be one wherein the first computer system is a server, e.g. a dedicated server, e.g. a machine in the cloud with dedicated GPUs e.g. Amazon Web Services, Microsoft Azure, etc., or any other cloud computing services.

The system may be one wherein the first computer system is a user device.

The system may be one wherein the user device is a laptop computer, desktop computer, a tablet computer or a smart phone.

The system may be one wherein the first trained neural network includes a library installed on the first computer system.

The system may be one wherein the first trained neural network is parametrized by one or several convolution matrices Θ, or the first trained neural network is parametrized by a set of bias parameters, non-linearity parameters, convolution kernel/matrix parameters.

The system may be one wherein the second computer system is a recipient device.

The system may be one wherein the recipient device is a laptop computer, desktop computer, a tablet computer, a smart TV or a smart phone.

The system may be one wherein the second trained neural network includes a library installed on the second computer system.

The system may be one wherein the second trained neural network is parametrized by one or several convolution matrices Ω, or the second trained neural network is parametrized by a set of bias parameters, non-linearity parameters, convolution kernel/matrix parameters.

According to a sixth aspect of the invention, there is provided a computer-implemented method of training an image generative network f_{θ} for a set of training images, in which an output image \hat{x} is generated from an input image x of the set of training images non-losslessly, in which a blindspot network b_{α} is trained which generates an output image \tilde{x} from an input image x, in which a proxy network is trained for a gradient intractable perceptual metric that evaluates a quality of an output image \hat{x} given an input image x, and in which a blindspot proxy network is trained for labelling blindspot samples, the method including the steps of;
(i) the blindspot network b_{α} generating an output image \hat{x} from an input image x of the set of training images;
(ii) the blindspot proxy network outputting a blindspot function output \tilde{y}, using x and \tilde{x} as inputs;
(iii) the gradient intractable perceptual metric outputting a function output y, using x and \tilde{x} as inputs;
(iv) evaluating a loss for the blindspot network, using y and \tilde{y} as inputs;
(v) using backpropagation to compute gradients of parameters of the blindspot network with respect to the loss evaluated in step (iv);
(vi) optimizing the parameters of the blindspot network based on the results of step (v), to provide an optimized blindspot network;
(vii) the image generative network f_{θ} generating an output image \hat{x} from an input image x, without tracking gradients for f_{θ};
(viii) the proxy network outputting an approximated function output ŷ, using x and \hat{x} as inputs;
(ix) the gradient intractable perceptual metric outputting a function output y, using x and \hat{x} as inputs;
(x) evaluating a loss for the proxy network, using y and ŷ as inputs;
(xi) using backpropagation to compute gradients of parameters of the proxy network with respect to the loss evaluated in step (x);
(xii) optimizing the parameters of the proxy network based on the results of step (xi), to provide an optimized proxy network;
(xiii) the blindspot network b_{α} generating an output image \tilde{x} from an input image x, without tracking gradients for b_{α};
(xiv) the blindspot proxy network outputting a representation \tilde{y}, using x and \tilde{x} as inputs;
(xv) a blindspot label function outputting a labelled output y of a blindspot sample;
(xvi) evaluating a loss for the blindspot proxy network, using y and \tilde{y} as inputs;
(xvii) using backpropagation to compute gradients of parameters of the blindspot proxy network with respect to the loss evaluated in step (xvi);
(xviii) optimizing the parameters of the blindspot proxy network based on the results of step (xvii), to provide an optimized proxy network;
(xix) the image generative network f_{θ} generating an output image \hat{x} from an input image x;
(xx) the optimized proxy network outputting an optimized approximated function output ŷ, using x and \hat{x} as inputs;
(xxi) evaluating a loss for the generative network f_{θ}, using x, \hat{x} and the optimized approximated function output ŷ as inputs;
(xxii) using backpropagation to compute gradients of parameters of the generative network f_{θ} with respect to the loss evaluated in step (xxi);
(xxiii) optimizing the parameters of the generative network f_{θ} based on the results of step (xxii), to provide an optimized generative network f_{θ}, and
(xxiv) repeating steps (i) to (xxiii) for each member of the set of training images.

An advantage is that the trained generative network is more robust against blind spots. An advantage is that the trained generative network is more robust against artifact generation. An advantage is that the proxy network is more robust against adversarial samples. An advantage is that the proxy network is more robust against artifact generation. An advantage is that within the field of learned image and video compression, the method allows networks to train with non-differentiable perceptual metrics.

The method may be one in which the method is repeated for the set of training images to train the generative network f_{θ}, to train the blindspot network b_{α}, to train the blindspot proxy network and to train the proxy network.

The method may be one including the step of: (xxv) storing the parameters of the trained generative network f_{θ}, the parameters of the trained blindspot network b_{α}, the parameters of the trained blindspot proxy network and the parameters of the trained proxy network.

The method may be one wherein a plurality of scales are used for input image x. An advantage is improved stability during the training. An advantage is that the proxy network is more robust against adversarial samples. An advantage is that the proxy network is more robust against artifact generation.

The method may be one wherein a regularisation term is added to the loss for the generative network f_{θ}, in which the term includes a function that penalises the generative network when predicting adversarial samples. An advantage is improved stability during the training. An advantage is that the proxy network is more robust against adversarial samples. An advantage is that the proxy network is more robust against artifact generation.

The method may be one wherein a function that penalises the generative network when predicting adversarial samples is a pixelwise error for perceptual proxy losses. An advantage is improved stability during the training. An advantage is that the proxy network is more robust against adversarial samples. An advantage is that the proxy network is more robust against artifact generation.

The method may be one wherein the regularisation term acts as a deterrent for the generative model, and steers it away from finding a basin on the loss surface which satisfies the proxy and the target function, but which includes blind spot samples. An advantage is improved stability during the training.

The method may be one wherein the regularisation term forces the model to find another basin to settle in. An advantage is that the proxy network is more robust against adversarial samples. An advantage is that the proxy network is more robust against artifact generation.

The method may be one wherein the regularisation term produces high loss values for adversarial images. An advantage is that the proxy network is more robust against adversarial samples. An advantage is that the proxy network is more robust against artifact generation.

The method may be one wherein a regularisation function is found by evaluating a set of loss functions on a set of adversarial samples, and selecting the loss function which produces the highest loss term. An advantage is that the proxy network is more robust against adversarial samples. An advantage is that the proxy network is more robust against artifact generation.

The method may be one wherein mitigation of blind spot samples is performed by training the proxy on samples with self imposed labels to force the network components to avoid the blind spot boundaries in the loss surface.

The method may be one wherein adversarial samples are collected, either from a model that is known to produce adversarial samples or synthetically generated by an algorithm which adds noise or artefacts that resemble the artefacts seen on adversarial samples; this stored set of adversarial images are each assigned a label such that a respective label conveys to the blindspot proxy network that a respective sample is an undesired sample. An advantage is that the proxy network is more robust against adversarial samples. An advantage is that the proxy network is more robust against artifact generation.

The method may be one wherein during the blindspot proxy network training, the input images are obtained from the generative model and the labels are obtained from the loss function of the blindspot proxy network.

The method may be one wherein the blindspot proxy network is trained once on the adversarial sample for every N samples from the generative model, where N>1, e.g. N=20.

The method may be one wherein an online method of generating the adversarial samples is provided.

The method may be one wherein in this method there exists a network configuration that only generates adversarial samples during its training by default, due to some model miss-specification; wherein this network, referred to as the blind spot network, produces adversarial samples for our blindspot proxy network loss function and therefore helps to define the underlying non-differentiable function.

The method may be one wherein the blind spot network is used to generate adversarial samples to train the proxy against.

The method may be one wherein a set of adversarial samples is not stored, but are instead generated in an online fashion using the blind-spot network, which is also learning.

According to a seventh aspect of the invention, there is provided a computer system configured to train an image generative network f_{θ} for a set of training images, in which an output image x is generated from an input image x of the set of training images non-losslessly, in which a blindspot network b_{α} is trained which generates an output image \tilde{x} from an input image x, in which a proxy network is trained for a gradient intractable perceptual metric that evaluates a quality of an output image \hat{x} given an input image x, and in which a blindspot proxy network is trained for labelling blindspot samples, wherein the computer system is configured to:
(i) use the blindspot network b_{α} to generate an output image \tilde{x} from an input image x of the set of training images;
(ii) use the blindspot proxy network to output a blindspot function output \tilde{y}, using x and \tilde{x} as inputs;
(iii) use the gradient intractable perceptual metric to output a function output y, using x and \tilde{x} as inputs;
(iv) evaluate a loss for the blindspot network, using y and \tilde{y} as inputs;
(v) use backpropagation to compute gradients of parameters of the blindspot network with respect to the loss evaluated in (iv);
(vi) optimize the parameters of the blindspot network based on the results of (v), to provide an optimized blindspot network;
(vii) use the image generative network f_{θ} to generate an output image \hat{x} from an input image x, without tracking gradients for f_{θ};
(viii) use the proxy network to output an approximated function output ŷ, using x and \hat{x} as inputs;
(ix) use the gradient intractable perceptual metric to output a function output y, using x and \hat{x} as inputs;
(x) evaluate a loss for the proxy network, using y and ŷ as inputs;
(xi) use backpropagation to compute gradients of parameters of the proxy network with respect to the loss evaluated in (x);
(xii) optimize the parameters of the proxy network based on the results of (xᵢ), to provide an optimized proxy network;
(xiii) use the blindspot network b_{α} to generate an output image \tilde{x} from an input image x, without tracking gradients for b_{α};
(xiv) use the blindspot proxy network to output a representation \tilde{y}, using x and \tilde{x} as inputs;
(xv) use a blindspot label function to output a labelled output y of a blindspot sample;
(xvi) evaluate a loss for the blindspot proxy network, using y and \tilde{y} as inputs;
(xvii) use backpropagation to compute gradients of parameters of the blindspot proxy network with respect to the loss evaluated in (xvi);
(xviii) optimize the parameters of the blindspot proxy network based on the results of (xvii), to provide an optimized proxy network;
(xix) use the image generative network f_{θ} to generate an output image \hat{x} from an input image x;
(xx) use the optimized proxy network to output an optimized approximated function output ŷ, using x and \hat{x} as inputs;
(xxi) evaluate a loss for the generative network f_{θ}, using x, \hat{x} and the optimized approximated function output ŷ as inputs;
(xxii) use backpropagation to compute gradients of parameters of the generative network f_{θ} with respect to the loss evaluated in (xxi);
(xxiii) optimize the parameters of the generative network f_{θ} based on the results of
(xxii), to provide an optimized generative network f_{θ}, and
(xxiv) repeat (i) to (xxiii) for each member of the set of training images.

The system may be one in which (i) to (xxiv) are repeated for the set of training images to train the generative network f_{θ}, to train the blindspot network b_{α}, to train the blindspot proxy network and to train the proxy network.

The system may be one in which the parameters are stored of the trained generative network f_{θ}, the parameters of the trained blindspot network b_{α}, the parameters of the trained blindspot proxy network and the parameters of the trained proxy network.

The computer system may be configured to perform a method of any aspect of the sixth aspect of the invention.

According to an eighth aspect of the invention, there is provided a computer program product executable on a processor to train an image generative network f_{θ} for a set of training images, in which an output image \hat{x} is generated from an input image x of the set of training images non-losslessly, in which a blindspot network b_{α} is trained which generates an output image \tilde{x} from an input image x, in which a proxy network is trained for a gradient intractable perceptual metric that evaluates a quality of an output image \hat{x} given an input image x, and in which a blindspot proxy network is trained for labelling blindspot samples, the computer program product executable to:
(i) use the blindspot network b_{α} to generate an output image \tilde{x} from an input image x of the set of training images;
(ii) use the blindspot proxy network to output a blindspot function output \tilde{y}, using x and \tilde{x} as inputs;
(iii) use the gradient intractable perceptual metric to output a function output y, using x and \tilde{x} as inputs;
(iv) evaluate a loss for the blindspot network, using y and \tilde{y} as inputs;
(v) use backpropagation to compute gradients of parameters of the blindspot network with respect to the loss evaluated in (iv);
(vi) optimize the parameters of the blindspot network based on the results of (v), to provide an optimized blindspot network;
(vii) use the image generative network f_{θ} to generate an output image \hat{x} from an input image x, without tracking gradients for f_{θ};
(viii) use the proxy network to output an approximated function output ŷ, using x and \hat{x} as inputs;
(ix) use the gradient intractable perceptual metric to output a function output y, using x and \hat{x} as inputs;
(x) evaluate a loss for the proxy network, using y and ŷ as inputs;
(xi) use backpropagation to compute gradients of parameters of the proxy network with respect to the loss evaluated in (x);
(xii) optimize the parameters of the proxy network based on the results of (xi), to provide an optimized proxy network;
(xiii) use the blindspot network b_{α} to generate an output image \tilde{x} from an input image x, without tracking gradients for b_{α};
(xiv) use the blindspot proxy network to output a representation \tilde{y}, using x and \tilde{x} as inputs;
(xv) use a blindspot label function to output a labelled output y of a blindspot sample;
(xvi) evaluate a loss for the blindspot proxy network, using y and \tilde{y} as inputs;
(xvii) use backpropagation to compute gradients of parameters of the blindspot proxy network with respect to the loss evaluated in (xvi);
(xviii) optimize the parameters of the blindspot proxy network based on the results of (xvii), to provide an optimized proxy network;
(xix) use the image generative network f_{θ} to generate an output image \hat{x} from an input image x;
(xx) use the optimized proxy network to output an optimized approximated function output ŷ, using x and \hat{x} as inputs;
(xxi) evaluate a loss for the generative network f_{θ}, using x, \hat{x} and the optimized approximated function output ŷ as inputs;
(xxii) use backpropagation to compute gradients of parameters of the generative network f_{θ} with respect to the loss evaluated in (xxi);
(xxiii) optimize the parameters of the generative network f_{θ} based on the results of
(xxii), to provide an optimized generative network f_{θ}, and
(xxiv) repeat (i) to (xxiii) for each member of the set of training images.

The computer program product may be executable to repeat (i) to (xxiv) for the set of training images to train the generative network f_{θ}, to train the blindspot network b_{α}, to train the blindspot proxy network and to train the proxy network.

The computer program product may be executable to store the parameters of the trained generative network f_{θ}, the parameters of the trained blindspot network b_{α}, the parameters of the trained blindspot proxy network and the parameters of the trained proxy network.

The computer program product may be executable on the processor to perform a method of any aspect of the sixth aspect of the invention.

According to a ninth aspect of the invention, there is provided a computer-implemented method of training an image generative network f_{θ} for a set of training images, in which an output image \hat{x} is generated from an input image x of the set of training images non-losslessly, in which a blindspot network b_{α} is trained which generates an output image \tilde{x} from an input image x, in which a proxy network is trained for a gradient intractable perceptual metric that evaluates a quality of an output image \hat{x} given an input image x, and in which a blindspot proxy network is trained for labelling blindspot samples.

The method may be one including a method of any aspect of the sixth aspect of the invention.

According to a tenth aspect of the invention, there is provided a system including a first computer system and a second computer system, the first computer system including a lossy encoder including a first trained neural network, the second computer system including a decoder including a second trained neural network, wherein the second computer system is in communication with the first computer system, the lossy encoder configured to produce a bitstream from an input image: the first computer system configured to transmit the bitstream to the second computer system, wherein the decoder is configured to decode the bitstream to produce an output image: wherein the first computer system in communication with the second computer system comprises a generative network, wherein the generative network is trained using a method of any aspect of the sixth aspect of the invention.

The system may be one for image or video compression, transmission and decoding, wherein
(i) the first computer system is configured to receive an input image;
(ii) the first computer system is configured to encode the input image using the first trained neural network, to produce a latent representation;
(iii) the first computer system is configured to quantize the latent representation to produce a quantized latent;
(iv) the first computer system is configured to entropy encode the quantized latent into a bitstream;
(v) the first computer system is configured to transmit the bitstream to the second computer system;
(vi) the second computer system is configured to entropy decode the bitstream to produce the quantized latent;
(vii) the second computer system is configured to use the second trained neural network to produce an output image from the quantized latent, wherein the output image is an approximation of the input image. Quantizing, entropy encoding and entropy decoding details are provided in PCT/GB2021/051041.

According to an eleventh aspect of the invention, there is provided a computer-implemented method of training an image generative network f_{θ} for a set of training images, in which an output image \hat{x} is generated from an input image x of the set of training images non-losslessly, and in which a proxy network is trained for a gradient intractable perceptual metric that evaluates a quality of an output image \hat{x} given an input image x, the method including the steps of:
(i) the image generative network f_{θ} generating an output image \hat{x} from an input image x of the set of training images, without tracking gradients for f_{θ};
(ii) the proxy network outputting an approximated function output ŷ, using x and \hat{x} as inputs;
(iii) the gradient intractable perceptual metric outputting a function output y, using x and \hat{x} as inputs;
(iv) evaluating a loss for the proxy network, using y and ŷ as inputs;
(v) using backpropagation to compute gradients of parameters of the proxy network with respect to the loss evaluated in step (iv);
(vi) optimizing the parameters of the proxy network based on the results of step (v), to provide an optimized proxy network;
(vii) the image generative network f_{θ} generating an output image x from an input image x,
(viii) the optimized proxy network outputting an optimized approximated function output ŷ, using x and \hat{x} as inputs;
(ix) evaluating a loss for the generative network f_{θ}, using x, \hat{x} and the optimized approximated function output ŷ as inputs;
(x) using backpropagation to compute gradients of parameters of the generative network f_{θ} with respect to the loss evaluated in step (ix);
(xᵢ) optimizing the parameters of the generative network f_{θ} based on the results of step (x), to provide an optimized generative network f_{θ}, and
(xii) repeating steps (i) to (xᵢ) for each member of the set of training images.

An advantage is that the proxy network is more robust against adversarial samples. An advantage is that the proxy network is more robust against artifact generation. An advantage is that within the field of learned image and video compression, the method allows networks to train with non-differentiable perceptual metrics.

The method may be one wherein the method is repeated for the set of training images, to train the generative network f_{θ} and to train the proxy network.

The method may be one including the step (xiii) of storing the parameters of the trained generative network f_{θ} and the parameters of the trained proxy network.

The method may be one wherein the image generative network f_{θ} is a neural network.

The method may be one wherein the proxy network is a neural network.

According to a twelfth aspect of the invention, there is provided a computer system configured to train an image generative network f_{θ} for a set of training images, in which an output image \hat{x} is generated from an input image x of the set of training images non-losslessly, and in which a proxy network is trained for a gradient intractable perceptual metric that evaluates a quality of an output image \hat{x} given an input image x, the computer system configured to:
(i) use the image generative network f_{θ} to generate an output image \hat{x} from an input image x of the set of training images, without tracking gradients for f_{θ};
(ii) use the proxy network to output an approximated function output ŷ, using x and \hat{x} as inputs;
(iii) use the gradient intractable perceptual metric to output a function output y, using x and \hat{x} as inputs;
(iv) evaluate a loss for the proxy network, using y and ŷ as inputs;
(v) use backpropagation to compute gradients of parameters of the proxy network with respect to the loss evaluated in (iv);
(vi) optimize the parameters of the proxy network based on the results of (v), to provide an optimized proxy network;
(vii) use the image generative network f_{θ} to generate an output image \hat{x} from an input image x,
(viii) use the optimized proxy network to output an optimized approximated function output ŷ, using x and \hat{x} as inputs;
(ix) evaluate a loss for the generative network f_{θ}, using x, \hat{x} and the optimized approximated function output ŷ as inputs;
(x) use backpropagation to compute gradients of parameters of the generative network f_{θ} with respect to the loss evaluated in (ix);
(xᵢ) optimize the parameters of the generative network f_{θ} based on the results of (x), to provide an optimized generative network f_{θ}, and
(xii) repeat (i) to (xi) for each member of the set of training images.

The computer system may be one wherein (i) to (xii) are repeated for the set of training images, to train the generative network f_{θ} and to train the proxy network.

The computer system may be configured to perform a method of any aspect of the eleventh aspect of the invention.

According to a thirteenth aspect of the invention, there is provided a computer program product executable on a processor to train an image generative network f_{θ} for a set of training images, in which an output image \hat{x} is generated from an input image x of the set of training images non-losslessly, and in which a proxy network is trained for a gradient intractable perceptual metric that evaluates a quality of an output image \hat{x} given an input image x, the computer program product executable to:
(i) use the image generative network f_{θ} to generate an output image \hat{x} from an input image x of the set of training images, without tracking gradients for f_{θ};
(ii) use the proxy network to output an approximated function output ŷ, using x and \hat{x} as inputs;
(iii) use the gradient intractable perceptual metric to output a function output y, using x and \hat{x} as inputs;
(iv) evaluate a loss for the proxy network, using y and ŷ as inputs;
(v) use backpropagation to compute gradients of parameters of the proxy network with respect to the loss evaluated in (iv);
(vi) optimize the parameters of the proxy network based on the results of (v), to provide an optimized proxy network;
(vii) use the image generative network f_{θ} to generate an output image \hat{x} from an input image x,
(viii) use the optimized proxy network to output an optimized approximated function output ŷ, using x and \hat{x} as inputs;
(ix) evaluate a loss for the generative network f_{θ}, using x, \hat{x} and the optimized approximated function output ŷ as inputs;
(x) use backpropagation to compute gradients of parameters of the generative network f_{θ} with respect to the loss evaluated in (ix);
(xᵢ) optimize the parameters of the generative network f_{θ} based on the results of (x), to provide an optimized generative network f_{θ}, and
(xii) repeat (i) to (xᵢ) for each member of the set of training images.

The computer program product may be one wherein (i) to (xii) are repeated for the set of training images, to train the generative network f_{θ} and to train the proxy network.

The computer program product may be executable on the processor to perform a method of any aspect of the eleventh aspect of the invention.

According to a fourteenth aspect of the invention, there is provided a computer-implemented method of training an image generative network f_{θ} for a set of training images, in which an output image \hat{x} is generated from an input image x of the set of training images non-losslessly, and in which a proxy network is trained for a gradient intractable perceptual metric that evaluates a quality of an output image \hat{x} given an input image x.

The method may include a method of any aspect of the eleventh aspect of the invention.

According to a fifteenth aspect of the invention, there is provided a system including a first computer system and a second computer system, the first computer system including a lossy encoder including a first trained neural network, the second computer system including a decoder including a second trained neural network, wherein the second computer system is in communication with the first computer system, the lossy encoder configured to produce a bitstream from an input image: the first computer system configured to transmit the bitstream to the second computer system, wherein the decoder is configured to decode the bitstream to produce an output image: wherein the first computer system in communication with the second computer system comprises a generative network, wherein the generative network is trained using a method of any aspect of the eleventh aspect of the invention.

The system may be one in which the system is for image or video compression, transmission and decoding, wherein
(i) the first computer system is configured to receive an input image;
(ii) the first computer system is configured to encode the input image using the first trained neural network, to produce a latent representation;
(iii) the first computer system is configured to quantize the latent representation to produce a quantized latent;
(iv) the first computer system is configured to entropy encode the quantized latent into a bitstream;
(v) the first computer system is configured to transmit the bitstream to the second computer system;
(vi) the second computer system is configured to entropy decode the bitstream to produce the quantized latent;
(vii) the second computer system is configured to use the second trained neural network to produce an output image from the quantized latent, wherein the output image is an approximation of the input image. Quantizing, entropy encoding and entropy decoding details are provided in PCT/GB2021/051041.

Aspects of the invention may be combined.

In the above methods and systems, an image may be a single image, or an image may be a video image, or images may be a set of video images, for example.

The above methods and systems may be applied in the video domain.

A network may be a neural network. Networks may be neural networks.

For each of the above methods, a related system may be provided.

For each of the above training methods, a related computer program product may be provided.

### BRIEF DESCRIPTION OF THE FIGURES

Aspects of the invention will now be described, by way of example(s), with reference to the following Figures, in which:

FIG. 1 shows an example of a generative network f_{θ}(x)=\hat{x}, and a differentiable proxy network ĥ_{ϕ}(x, \hat{x})=ŷ which approximates a non-differentiable target function (GIF) h_{ζ}(x,\hat{x})=y. Note, we can train both networks f_{θ} and ĥ_{ϕ} at the same time.

FIG. 2A shows an example in which a training of f_{θ} requires gradient flow via ĥ_{ϕ} and parameter updates from the optimiser opt{f_{θ}}. The dotted arrows indicate schematically the direction of back-propagation.

FIG. 2B shows an example in which a training of ĥ_{ϕ} involves samples of f_{θ}(x) and x, but does not require gradients for \hat{x}. ĥ_{ϕ} is trained to minimise the loss L_{proxy}(ŷ,y) with optimizer opt {ĥ_{ϕ}}. The dotted arrows indicate schematically the direction of back-propagation.

FIG. 3 shows an example of a structure of a proxy network ĥ_{ϕ}(x,\hat{x})=ŷ.

FIG. 4 shows an example of a resblock component with 3 internal blocks (×3). For example “(128, 256, 2)” indicates there are 128 channels in a, 256 channels in β and “2” indicates a stride of 2 is used to downsample at the end of the sequence. The circle with a “+” at its centre indicates element-wise addition. For example “Conv2d(128, 128, 1)” indicates a 2D convolutional operation of input channels of size 128, output channels of size 128, stride of 1 and a default padding of size stride/2.

FIG. 5 shows an example in which an auto-encoder is the generative network of FIG. 1.

FIG. 6 shows an example of adversarial samples generated by a generative network f_{θ} where h_{ζ}is VMAF. The white bounding boxes indicate the corresponding enlarged regions in FIG. 7. Note that the distorted image has a VMAF score of 85 out of approximately 96.

FIG. 7 shows an example of adversarial samples generated by the generative network f_{θ} where h_{ζ} is VMAF. The images shown in the figure are enlarged views of the corresponding regions contained within the white bounding boxes shown in FIG. 6. Notice the checkerboard-like artifacts in the distorted image which have been learnt by the generative network f_{θ} as a method of minimizing the loss corresponding to f_{θ} because VMAF is susceptible to these types of artifacts which are possibly outside the boundary for which the function is well-defined, i.e. these artifacts align well with human perception, and the generative network f_{θ} considers images with these artifacts perceptually more similar. The distorted image is referred to as an adversarial sample.

FIG. 8 shows an example of multiscale training for the case of images x∈ [symbol] ³ where for each image x, an RGB image at three different scales is provided. The generative network, along with the proxy and perceptual metric process each scale of image and perform an aggregation at the end using some function, such as a mean operator.

FIG. 9 shows a training example in which a set of adversarial samples \tilde{X}ᵢ is introduced, with associated labels \tilde{y}ᵢ. The loss surface of ĥ_{ϕ} is directly discouraged to enter blind spots by training against the sample set [symbol] ᵢ with self-imposed label set ŷᵢ.

FIG. 10 shows a training example in which a blind spot network is introduced, with associated outputs \tilde{x}ᵢ. The loss surface of ĥ_{ϕ} is directly discouraged to enter boundaries of blind spots by training against the samples from the blind spot network with self-imposed labels ŷᵢ. The blind spot network itself is trained using a proxy network. The blind spot network can either use the same (as in this figure) or a different proxy network (not shown) from the encoder decoder network.

FIG. 11 shows a schematic diagram of an artificial intelligence (AI)-based compression process, including encoding an input image x using a neural network E( . . . ), and decoding using a neural network D( . . . ), to provide an output image x. Runtime issues are relevant to the Encoder. Runtime issues are relevant to the Decoder. Examples of issues of relevance to parts of the process are identified.

### DETAILED DESCRIPTION

### Technology Overview

We provide a high level overview of some aspects of our artificial intelligence (AI)-based (e.g. image and/or video) compression technology.

In general, compression can be lossless, or lossy. In lossless compression, and in lossy compression, the file size is reduced. The file size is sometimes referred to as the “rate”.

But in lossy compression, it is possible to change what is input. The output image \hat{x} after reconstruction of a bitstream relating to a compressed image is not the same as the input image x. The fact that the output image \hat{x} may differ from the input image x is represented by the hat over the “x”. The difference between x and \hat{x} may be referred to as “distortion”, or “a difference in image quality”. Lossy compression may be characterized by the “output quality”, or “distortion”.

Although our pipeline may contain some lossless compression, overall the pipeline uses lossy compression.

Usually, as the rate goes up, the distortion goes down. A relation between these quantities for a given compression scheme is called the “rate-distortion equation”. For example, a goal in improving compression technology is to obtain reduced distortion, for a fixed size of a compressed file, which would provide an improved rate-distortion equation. For example, the distortion can be measured using the mean square error (MSE) between the pixels of x and \hat{x}, but there are many other ways of measuring distortion, as will be clear to the person skilled in the art. Known compression and decompression schemes include for example, JPEG, JPEG2000, AVC, HEVC, AVI.

In an example, our approach includes using deep learning and AI to provide an improved compression and decompression scheme, or improved compression and decompression schemes.

In an example of an artificial intelligence (AI)-based compression process, an input image x is provided. There is provided a neural network characterized by a function E( . . . ) which encodes the input image x. This neural network E( . . . ) produces a latent representation, which we call w. The latent representation is quantized to provide w, a quantized latent. The quantized latent goes to another neural network characterized by a function D( . . . ) which is a decoder. The decoder provides an output image, which we call \hat{x}. The quantized latent ŵ is entropy-encoded into a bitstream.

For example, the encoder is a library which is installed on a user device, e.g. laptop computer, desktop computer, smart phone. The encoder produces the w latent, which is quantized to ŵ, which is entropy encoded to provide the bitstream, and the bitstream is sent over the internet to a recipient device. The recipient device entropy decodes the bitstream to provide ŵ, and then uses the decoder which is a library installed on a recipient device (e.g. laptop computer, desktop computer, smart phone) to provide the output image \hat{x}.

E may be parametrized by a convolution matrix Θ such that w=E_{Θ}(x).

D may be parametrized by a convolution matrix Ω such that \hat{x}=D_{Ω}(w).

We need to find a way to learn the parameters Θ and Ω of the neural networks.

The compression pipeline may be parametrized using a loss function L. In an example, we use back-propagation of gradient descent of the loss function, using the chain rule, to update the weight parameters of Θ and Ω of the neural networks using the gradients ∂L/∂y.

The loss function is the rate-distortion trade off. The distortion function is [symbol] (x,\hat{x}), which produces a value, which is the loss of the distortion [symbol] . The loss function can be used to back-propagate the gradient to train the neural networks.

So for example, we use an input image, we obtain a loss function, we perform a backwards propagation, and we train the neural networks. This is repeated for a training set of input images, until the pipeline is trained. The trained neural networks can then provide good quality output images.

An example image training set is the KODAK image set (e.g. at www.cs.albany.edu/˜xypan/research/snr/Kodak.html). An example image training set is the IMAX image set. An example image training set is the Imagenet dataset (e.g. at www.image-net.org/download). An example image training set is the CLIC Training Dataset P (“professional”) and M (“mobile”) (e.g. at http://challenge.compression.cc/tasks/).

In an example, the production of the bitstream from w is lossless compression.

In the pipeline, the pipeline needs a loss that we can use for training, and the loss needs to resemble the rate-distortion trade off.

A loss which may be used for neural network training is Loss= [symbol] +λ*R, where [symbol] is the distortion function, λ is a weighting factor, and R is the rate loss. R is related to entropy. Both [symbol] and R are differentiable functions.

Distortion functions [symbol] (x,\hat{x}), which correlate well with the human vision system, are hard to identify. There exist many candidate distortion functions, but typically these do not correlate well with the human vision system, when considering a wide variety of possible distortions.

We want humans who view picture or video content on their devices, to have a pleasing visual experience when viewing this content, for the smallest possible file size transmitted to the devices. So we have focused on providing improved distortion functions, which correlate better with the human vision system. Modern distortion functions very often contain a neural network, which transforms the input and the output into a perceptional space, before comparing the input and the output. The neural network can be a generative adversarial network (GAN) which performs some hallucination. There can also be some stabilization. It turns out it seems that humans evaluate image quality over density functions.

Hallucinating is providing fine detail in an image, which can be generated for the viewer, where all the fine, higher spatial frequencies, detail does not need to be accurately transmitted, but some of the fine detail can be generated at the receiver end, given suitable cues for generating the fine details, where the cues are sent from the transmitter.

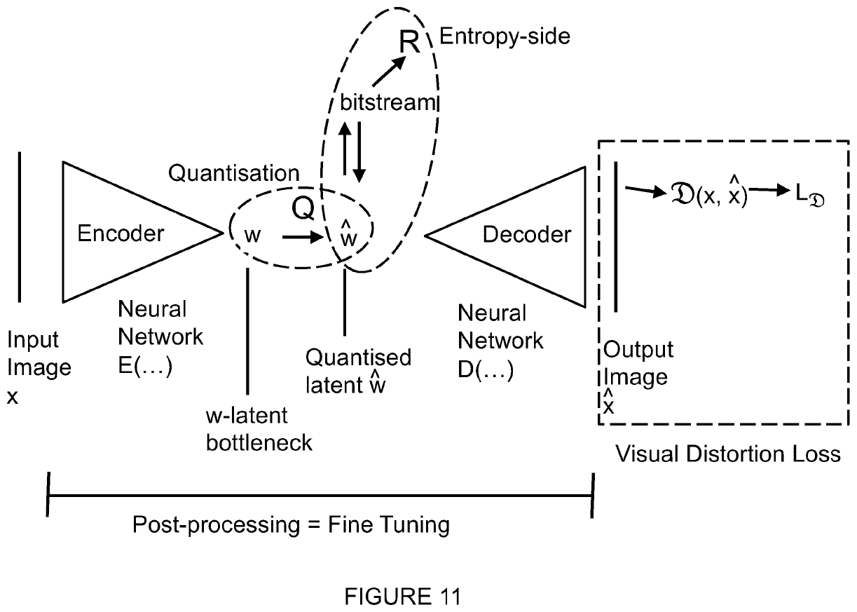

FIG. 11 shows a schematic diagram of an artificial intelligence (AI)-based compression process, including encoding an input image x using a neural network, and decoding using a neural network, to provide an output image î.

In an example of a layer in an encoder neural network, the layer includes a convolution, a bias and an activation function. In an example, four such layers are used.

There is provided a computer-implemented method for lossy image or video compression, transmission and decoding, the method including the steps of;
(i) receiving an input image at a first computer system;
(ii) encoding the input image using a first trained neural network, using the first computer system, to produce a latent representation;
(iii) quantizing the latent representation using the first computer system to produce a quantized latent;
(iv) entropy encoding the quantized latent into a bitstream, using the first computer system;
(v) transmitting the bitstream to a second computer system;
(vi) the second computer system entropy decoding the bitstream to produce the quantized latent;
(vii) the second computer system using a second trained neural network to produce an output image from the quantized latent, wherein the output image is an approximation of the input image. A related system including a first computer system, a first trained neural network, a second computer system and a second trained neural network, may be provided.

An advantage is that for a fixed file size (“rate”), a reduced output image distortion is obtained. An advantage is that for a fixed output image distortion, a reduced file size (“rate”) is obtained.

There is provided a computer implemented method of training a first neural network and a second neural network, the neural networks being for use in lossy image or video compression, transmission and decoding, the method including the steps of:
(i) receiving an input training image;
(ii) encoding the input training image using the first neural network, to produce a latent representation;
(iii) quantizing the latent representation to produce a quantized latent;
(iv) using the second neural network to produce an output image from the quantized latent, wherein the output image is an approximation of the input image;
(v) evaluating a loss function based on differences between the output image and the input training image;
(vi) evaluating a gradient of the loss function;
(vii) back-propagating the gradient of the loss function through the second neural network and through the first neural network, to update weights of the second neural network and of the first neural network; and
(viii) repeating steps (i) to (vii) using a set of training images, to produce a trained first neural network and a trained second neural network, and
(ix) storing the weights of the trained first neural network and of the trained second neural network. A related computer program product may be provided.

An advantage is that, when using the trained first neural network and the trained second neural network, for a fixed file size (“rate”), a reduced output image distortion is obtained; and for a fixed output image distortion, a reduced file size (“rate”) is obtained.

### Example Aspects of Adversarial Learning of Differentiable Proxy of Gradient Intractable Networks

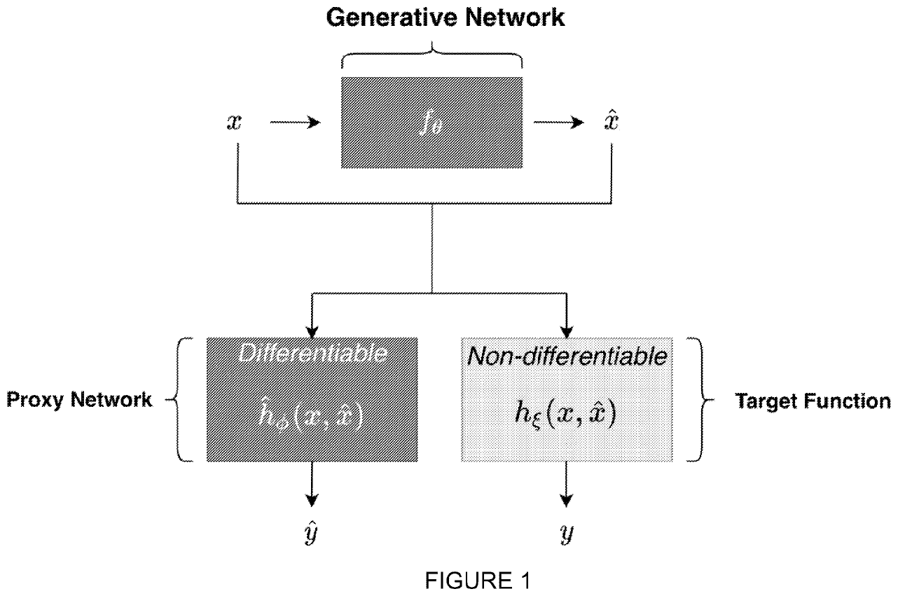

A generative network f_{θ} which generates an output image û from an input image x is provided. A differentiable proxy network ĥ_{ϕ} which generates a function output ŷ from x and \hat{x} according to ĥ_{ϕ}(x, \hat{x})=ŷ is provided. The differentiable proxy network ĥ_{ϕ} approximates a non-differentiable target function (GIF) h_{ζ} which generates a function output y from x and \hat{x} according to h_{ζ}(x, \hat{x})=y. It is possible to train both networks f_{θ} and ĥ_{ϕ} at the same time. An example is shown in FIG. 1.

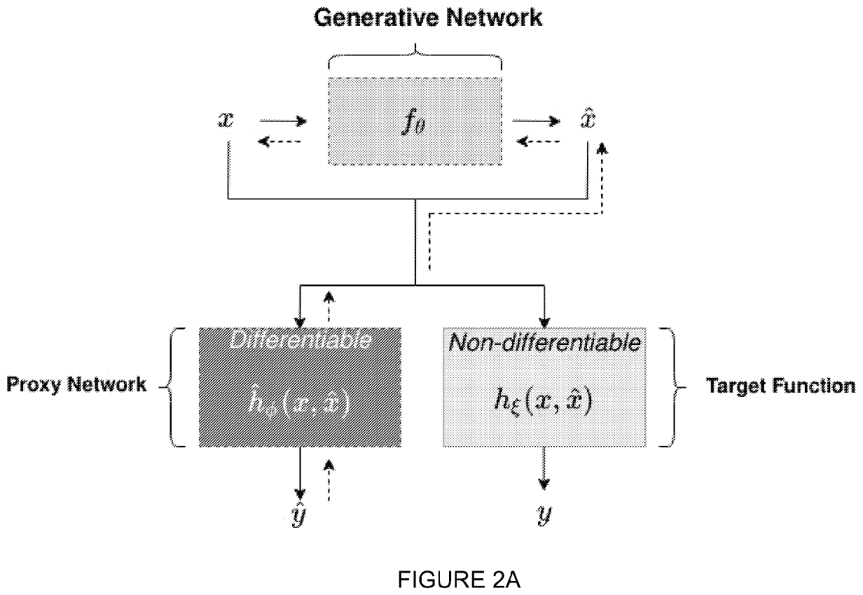

In an example, a training of f_{θ} requires gradient flow via ĥ_{ϕ} and parameter updates for f_{θ} from an optimiser opt {f_{θ}}. An example is shown in FIG. 2A, in which the dotted arrows indicate schematically the direction of back-propagation.

In an example, a training of ĥ_{ϕ} involves samples of f_{θ}(x) and x, but does not require gradients for \hat{x}. ĥ_{ϕ} is trained to minimise the loss L_{proxy}(ŷ,y) with optimizer opt {ĥ_{ϕ}}. An example is shown in FIG. 2B, in which the dotted arrows indicate schematically the direction of back-propagation.

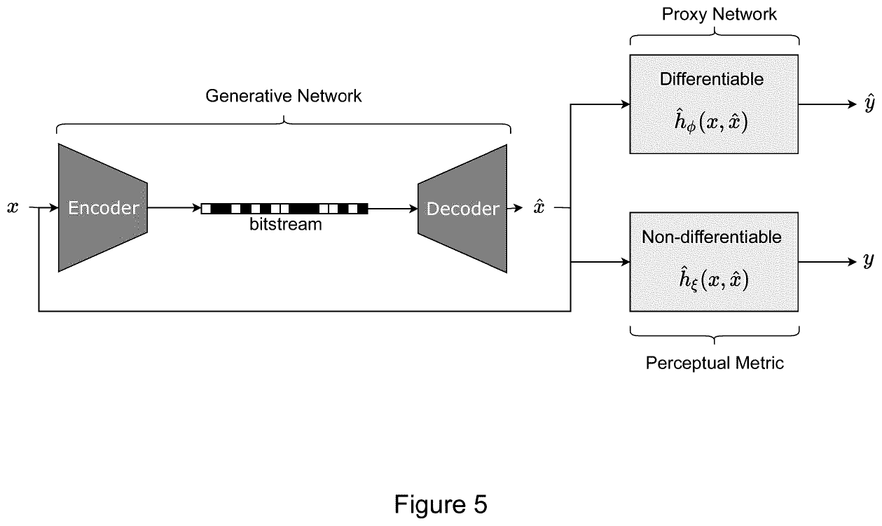

A generative network f_{θ} which generates an output image \hat{x} from an input image x is provided. In an example, the generative network f_{θ} includes an encoder, which encodes (e.g. which performs lossy encoding) an input image x into a bitstream, and includes a decoder, which decodes the bitstream into an output image \hat{x}. A differentiable proxy network h_{ϕ} which generates a function output ŷ from x and \hat{x} according to ĥ_{ϕ}(x, \hat{x})=ŷ is provided. The differentiable proxy network ĥ_{ϕ} approximates a non-differentiable target function (GIF) hg which generates a function output y from x and \hat{x} according to h_{ζ}(x, \hat{x})=y. It is possible to train both networks f_{θ} and ĥ_{ϕ} at the same time. An example is shown in FIG. 5.

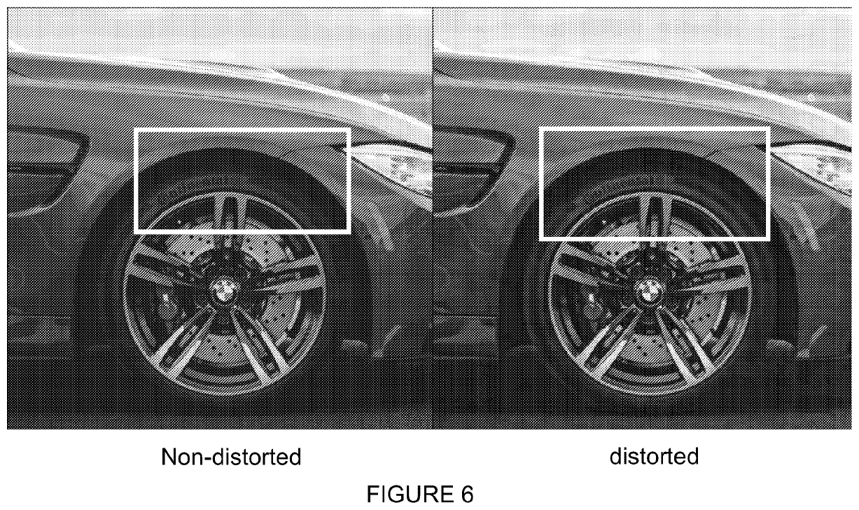

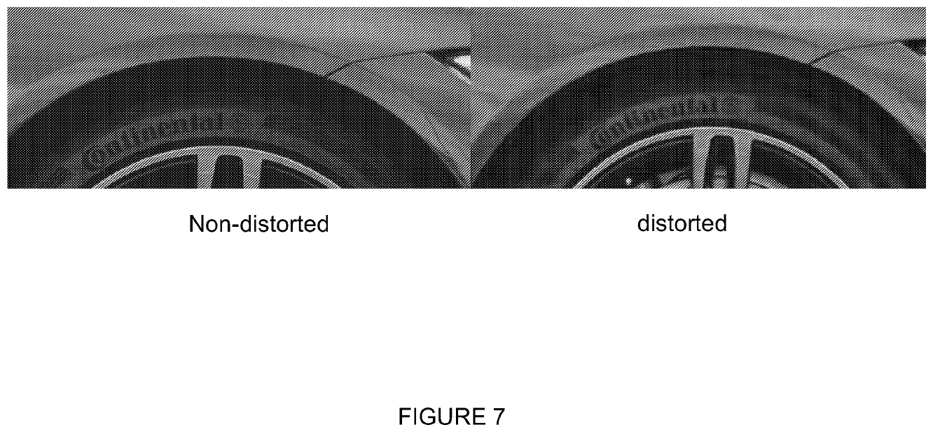

Adversarial samples may be generated by a generative network f_{θ} where h_{ζ} is VMAF. FIG. 6 shows an example of adversarial samples generated by a generative network f_{θ} where h_{ζ} is VMAF. The white bounding boxes indicate the corresponding enlarged regions in FIG. 7. Note that the distorted image has a VMAF score of 85 out of approximately 96.

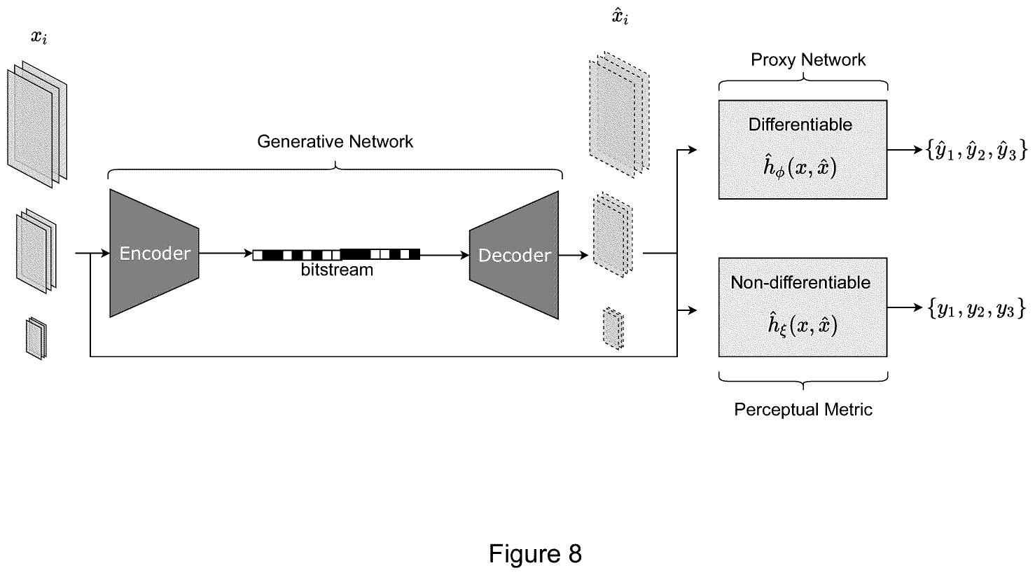

A generative network f_{θ} which generates an output image \hat{x}ᵢ from an input image xᵢ is provided. In an example, the generative network f_{θ} includes an encoder, which encodes (e.g. which performs lossy encoding) an input image xᵢ into a bitstream, and includes a decoder, which decodes the bitstream into an output image \hat{x}ᵢ. A differentiable proxy network ĥ_{ϕ} which generates a function output ŷᵢ from xᵢ and \hat{x}ᵢ according to ĥ_{ϕ}(xᵢ, \hat{x}ᵢ)=yᵢ is provided. The differentiable proxy network ĥ_{ϕ} approximates a non-differentiable target function (GIF) ĥζ which generates a function output yᵢ from xᵢ and \hat{x}ᵢ according to h_{ζ}(xᵢ, \hat{x}ᵢ)=yᵢ. It is possible to train both networks f_{θ} and ĥ_{ϕ} at the same time. Multiscale training is provided for the case of multiscale images xᵢ ∈ [symbol] ³ where for each image x, an RGB image at a plurality of different scales is used. The generative network f_{θ}, along with the proxy network ĥ_{ϕ} and the perceptual metric h_{ζ} process each scale of image and finally perform an aggregation using some aggregation function, such as a mean operator. FIG. 8 shows an example of multiscale training for the case of images xᵢ ∈ [symbol] ³ where for each image x, an RGB image at three different scales is provided: xᵢ, where i=1, 2 or 3.

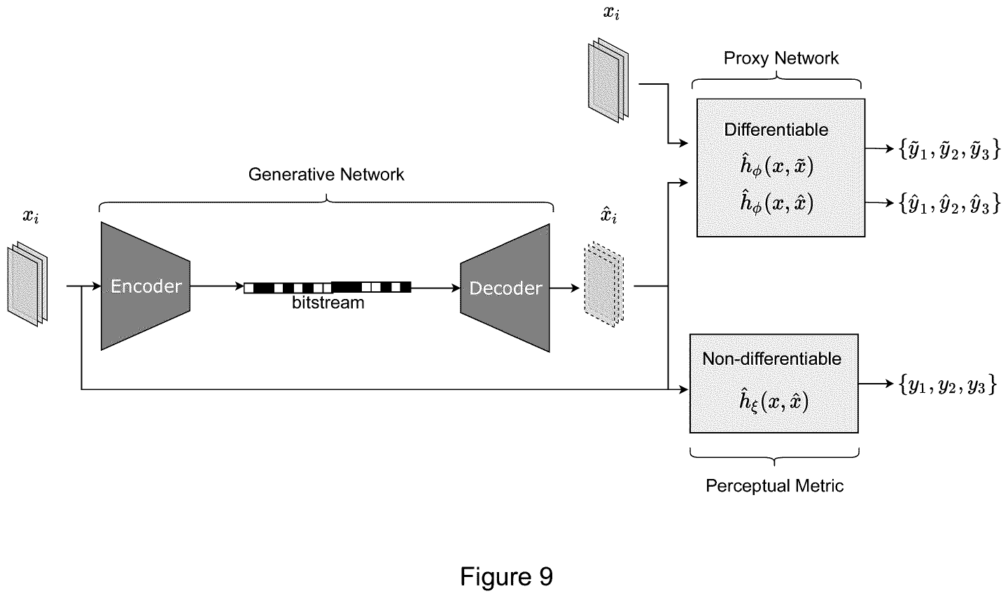

A generative network f_{θ} which generates an output image \hat{x}ᵢ from an input image xᵢ is provided. In an example, the generative network f_{θ} includes an encoder, which encodes (e.g. which performs lossy encoding) an input image xᵢ into a bitstream, and includes a decoder, which decodes the bitstream into an output image \hat{x}ᵢ. A differentiable proxy network ĥ_{ϕ} which generates a function output ŷᵢ from xᵢ and \hat{x}ᵢ according to ĥ_{ϕ}(xᵢ, \hat{x}ᵢ)=ŷᵢ is provided. The differentiable proxy network ĥ_{ϕ} approximates a non-differentiable target function (GIF) h_{ζ} which generates a function output yᵢ from xᵢ and \hat{x}ᵢ according to h_{ζ}(xᵢ, \hat{x}ᵢ)=yᵢ. It is possible to train both networks f_{θ} and ĥ_{ϕ} at the same time. Multiscale training is provided for the case of multiscale images xᵢ ∈ [symbol] ³ where for each image x, an RGB image at a plurality of different scales is used. The generative network f_{θ}, along with the proxy network ĥ_{ϕ} and the perceptual metric h_{ζ} process each scale of image and finally perform an aggregation using some aggregation function, such as a mean operator. In an example, a set of adversarial samples \tilde{x}ᵢ is introduced, with associated labels \tilde{y}ᵢ, which are generated according to ĥ_{ϕ}(xᵢ, \tilde{x}ᵢ)=\tilde{y}ᵢ. The loss surface of ĥ_{ϕ} is directly discouraged to enter blind spots by training against the sample set \tilde{x}ᵢ with self-imposed label set \tilde{y}ᵢ. FIG. 9 shows a training example in which a set of adversarial samples \tilde{x}ᵢ is introduced, with associated labels \tilde{y}ᵢ, and the loss surface of ĥ_{ϕ} is directly discouraged to enter blind spots by training against the sample set \tilde{x}ᵢ with self-imposed label set ŷᵢ.

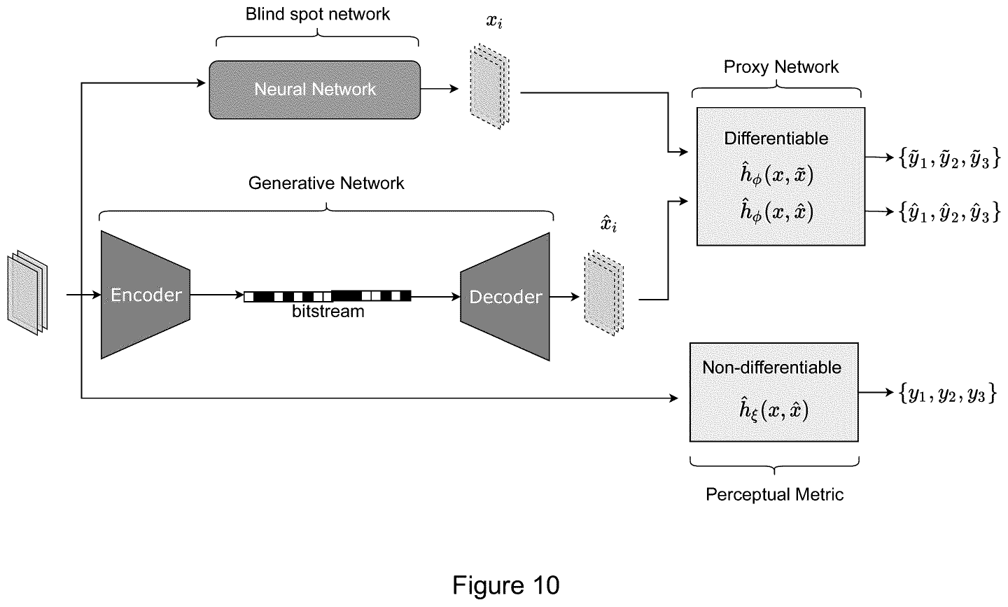

A generative network f_{θ} which generates an output image \hat{x}ᵢ from an input image xᵢ is provided. In an example, the generative network f_{θ} includes an encoder, which encodes (e.g. which performs lossy encoding) an input image xᵢ into a bitstream, and includes a decoder, which decodes the bitstream into an output image \hat{x}ᵢ. A differentiable proxy network ĥ_{ϕ} which generates a function output ŷᵢ from xᵢ and \hat{x}ᵢ according to ĥ_{ϕ}(xᵢ, \hat{x}ᵢ)=yᵢ is provided. The differentiable proxy network h_{ϕ} approximates a non-differentiable target function (GIF) ha which generates a function output yᵢ from xᵢ and \hat{x}ᵢ according to h_{ζ}(xᵢ, \hat{x}ᵢ)=yᵢ. It is possible to train both networks f_{θ} and ĥ_{ϕ} at the same time. Multiscale training may be provided for the case of multiscale images xᵢ ∈ [symbol] ³ where for each image x, an RGB image at a plurality of different scales is used. The generative network f_{θ}, along with the proxy network ĥ_{ϕ} and the perceptual metric ha process each scale of image and finally perform an aggregation using some aggregation function, such as a mean operator. In an example, a set of adversarial samples \tilde{x}ᵢ are generated by a blind spot network from a set of xᵢ. The \tilde{x}ᵢ have associated labels \tilde{y}ᵢ, which are generated according to ĥ_{ϕ}(xᵢ, \tilde{x}ᵢ)=\tilde{y}ᵢ. The loss surface of ĥ_{ϕ} is directly discouraged to enter blind spots by training against the sample set \tilde{x}ᵢ with self-imposed label set \tilde{y}ᵢ. The blind spot network itself may be trained using a proxy network. The blind spot network can either use the same (as in FIG. 10) or a different proxy network (not shown in FIG. 10) from the encoder decoder network. FIG. 10 shows a training example in which a blind spot network is present.

In an example of a trained generative network, an encoder including a first trained neural network is provided on a first computer system, and a decoder is provided on a second computer system in communication with the first computer system, the decoder including a second trained neural network. The encoder produces a bitstream from an input image: the bitstream is transmitted to the second computer system, where the decoder decodes the bitstream to produce an output image. The output image may be an approximation of the input image.

The first computer system may be a server, e.g. a dedicated server, e.g. a machine in the cloud with dedicated GPUs e.g. Amazon Web Services, Microsoft Azure, etc., or any other cloud computing services.

The first computer system may be a user device. The user device may be a laptop computer, desktop computer, a tablet computer or a smart phone.

The first trained neural network may include a library installed on the first computer system.

The first trained neural network may be parametrized by one or several convolution matrices Θ, or the first trained neural network may be parametrized by a set of bias parameters, non-linearity parameters, convolution kernel/matrix parameters. The second computer system may be a recipient device.

The recipient device may be a laptop computer, desktop computer, a tablet computer, a smart TV or a smart phone.

The second trained neural network may include a library installed on the second computer system.

The second trained neural network may be parametrized by one or several convolution matrices Ω, or the second trained neural network may be parametrized by a set of bias parameters, non-linearity parameters, convolution kernel/matrix parameters.

### Notes re VMAF

Video Multimethod Assessment Fusion (VMAF) is an objective full-reference video quality metric. It predicts subjective video quality based on a reference and distorted video sequence. The metric can be used to evaluate the quality of different video codecs, encoders, encoding settings, or transmission variants.

VMAF uses existing image quality metrics and other features to predict video quality:
Visual Information Fidelity (VIF): considers information fidelity loss at four different spatial scales.
Detail Loss Metric (DLM): measures loss of details, and impairments which distract viewer attention.
Mean Co-Located Pixel Difference (MCPD): measures temporal difference between frames on the luminance component.
Anti-noise signal-to-noise ratio (AN-SNR).

The above features are fused using a support-vector machine (SVM)-based regression to provide a single output score in the range of 0-100 per video frame, with 100 being quality identical to the reference video. These scores are then temporally pooled over the entire video sequence using the arithmetic mean to provide an overall differential mean opinion score (DMOS).

Due to the public availability of the training source code (“VMAF Development Kit”, VDK), the fusion method can be re-trained and evaluated based on different video datasets and features.

Regarding perceptual specific GIF's, some other examples apart from VMAF are:
VIF-Visual Information Fidelity
DLM-Detail Loss Metric
IFC-Information Fidelity Criterion.

Regarding perceptual specific GIF's, an example class of GIFs is mutual information based estimators.

### Notes re Training

Regarding seeding the neural networks for training, all the neural network parameters can be randomized with standard methods (such as Xavier Initialization). Typically, we find that satisfactory results are obtained with sufficiently small learning rates.

### Other Applications

As an alternative to applications described in this document which use a gradient intractable perceptual metric, the present invention may be re-purposed for applications relating to quantisation. In an application relating to quantisation, we can use a proxy network to learn any intractable gradient function in machine learning. So as an alternative to the perceptual metric, the quantisation (round) function may be used. A quantisation (round) function may be used in our pipeline on the latent space to convert it to a quantised latent space during encoding. This is a problem for training as a quantisation (round) function does not have usable gradients. It is possible to learn the quantisation (round) function using a proxy neural network (since we always know the ground truth values) and use this network (which allows gradients to be propagated) for quantisation during training. The method is similar to that described in the algorithms 1.1, 1.2 and 1.3, but the intractable gradient function is now the quantisation (round) function.

As an alternative to applications described in this document which use a gradient intractable perceptual metric, the present invention may be re-purposed for applications relating to a runtime device proxy. Techniques such as NAS (Network Architecture Search) can be used to drive the search for efficient architecture using the measured runtime on a device as the loss function to minimise. However, this is currently not possible as it's too time-consuming to execute each model on a device to assess its runtime per iteration of training. We use a proxy network to learn the mapping from architecture to runtime. This proxy is trained by generating 1000, or at least 1000, architectures randomly, timing their runtime on a device, and then fitting a neural network to this data. Having this runtime proxy allows us to get runtimes of architecture easily and within a few seconds of processing (e.g. through the forward pass of the proxy network). This proxy can be then be used as a stand-alone to assess run timings of architectures or in a NAS based setting to drive learning.

### Note

It is to be understood that the arrangements referenced herein are only illustrative of the application for the principles of the present inventions. Numerous modifications and alternative arrangements can be devised without departing from the spirit and scope of the present inventions. While the present inventions are shown in the drawings and fully described with particularity and detail in connection with what is presently deemed to be the most practical and preferred examples of the inventions, it will be apparent to those of ordinary skill in the art that numerous modifications can be made without departing from the principles and concepts of the inventions as set forth herein.

### 1. Adversarial Learning of Differentiable Proxy of Gradient Intractable Functions

### 1.1 Introduction

Modern machine learning algorithms are optimised using a method called stochastic gradient descent. This method allows us to update the parameters of our model to a specific. e.g. a user-specific, goal. The goal is controlled by defining a loss-function the network uses for backpropagation. A constraint of this method is that the loss function has to be differentiable at least once with respect to the input from the model. This differentiability allows us to compute the rate of change of every parameter in our network with respect to the loss, and update in such a way that it either minimises or maximises this goal.

There exist a set of functions which are either tedious to differentiate or non-differentiable altogether. However, some of these functions are extremely useful for a specific task, and it is desirable to use them as a goal for optimizing the model parameters. The non-differentiability of these functions limits our ability to use them in our models, preventing performance gains.

We outline a method which allows any arbitrarily complex non-differentiable function to be made differentiable, using a technique referred to as adversarial proxy learning. In essence, a neural network learns the mapping of this arbitrarily complex non-differentiable function; the proxy network. This proxy may then be used to train a different neural network, since the proxy is differentiable. Given that this proxy learns a (e.g. perfect) mapping of our desired non-differentiable function, optimising the parameters of a neural network using this proxy as a loss function is equivalent to optimising for the non-differentiable function.

Here we detail the use of an adversarial proxy to learn an arbitrary function. Further, we provide a specific case example, where the adversarial proxy is successfully used to learn a perceptual method. Additionally, we outline some issues that arise with such a training scheme along with solutions.

### 1.2 An Innovation

### 1.2.1 Adversarial Proxy

Artificial neural networks are known as universal approximators since they can approximate any real-valued continuous function on a compact subset d∈ [symbol] ⁿ arbitrarily well. Neural networks are usually trained using backpropagation. This method imposes the constraint of differentiability on all network components; gradients must be computed for all parts of the network. However, there may be instances where gradients are intractable. For a function h_{ζ}, if the function is non-differentiable or the gradients are intractable due to other reasons, network training is not possible under normal circumstances.

Here we present a novel method of learning gradient intractable functions (GIFs) during network training. We learn GIFs that are robust against adversarial examples by jointly learning the GIFs through a proxy and using them as a loss for a different network. An overview of a training process can be seen in the example of FIG. 1, where for a generic generative network f_{θ}(x)=\hat{x} the training loss must incorporate the GIF h_{ζ}(x, \hat{x})=y. Note that the number of input and output parameters to the GIF is arbitrary: two is used for simplicity. During the process of backpropagation there is a requirement that h_{ζ} be differentiable, because otherwise it is not known how a change in the output y affects the loss of the generative network f_{θ}. Therefore it is not clear how the generative network may update its weights to minimise the total loss [symbol] f_{θ} (x,\hat{x},y). This is shown explicitly in eq. 1.1 below. Gradients of the loss with respect to y, as shown in eq. 1.1, are intractable since

$$\frac{\partial {h}_{ξ} ( x , \hat{x} )}{\partial y}$$

cannot be computed.

$$\frac{\partial {ℒ}_{f θ} ( x , \hat{x} , y )}{\partial y} = \frac{\partial {ℒ}_{f θ}}{\partial {h}_{ξ} ( x , \hat{x} )} \frac{\partial {h}_{ξ} ( x , \hat{x} )}{\partial y} \qquad ( 1.1 )$$

In an example, gradients from h_{ζ} are required to train another network f_{θ}. A method of introducing approximate gradients originating at h_{ζ} is to learn a proxy network ĥ_{ϕ} that closely follows h_{ζ}; and then use the proxy network to produce the gradients used by the other network f_{θ}. Thus, we treat the gradients of ĥ_{ϕ} (x)=ŷ as a noisy, differentiable relaxation of the intractable gradients of the GIF h_{ζ}. Thus, given a fully pre-trained proxy network ĥ_{ϕ}, the generative network f_{θ} is able to compute approximate gradients for the GIF h_{ζ}, albeit with slight noise e in the signal. However because the pre-trained network ĥ_{ϕ} is frozen, f_{θ} will at some point learn to produce examples outside of the learnt boundary of ĥ_{ϕ}. This is referred to as an adversarial sample.

What is referred to above as adversarial samples, are undesired outputs \hat{x} generated by the generative network f_{θ} for which the proxy network ĥ_{ϕ} produces a low loss value Li_{ĥ}_{_{ϕ}}. The generator f_{θ} has learnt to exploit the proxy ĥ_{ϕ} by producing samples at a boundary region of the proxy network for which it is not well defined, or is not functioning as expected. A simple example of this is for perceptual image quality.

Here h_{ζ} is a full-reference perceptual metric that estimates the quality of a generated image \hat{x} given the original image x. If the generative network f_{θ} has learnt that small perturbations of pixel values (resulting in a type of noise or image degradation) produces better quality estimates from the proxy perceptual metric ĥ_{ϕ}, but a human would consider the image quality to actually worsen; that is referred to as a (perceptual) adversarial sample. Specifically, adversarial samples are samples produced by the generative network f_{θ} that exploit a blind spot in the proxy network ĥ_{ϕ} and the underlying function that is learnt.

Refer to the examples of FIG. 6 and FIG. 7 for adversarial samples that are manifested in the form of check-board-like pixel artifacts that exploit a blind spot in the particular perceptual loss metric (VMAF) h_{ζ} that was used.

The problem of adversarial samples originates from fixing our proxy network ĥ_{ϕ} (e.g. frozen weights) when training the other network f_{θ}. Robustness against adversarial samples is ensured through an end-to-end joint training process of f_{θ} and ĥ_{ϕ}, separated into two iterative steps:
1. One training pass of the generative network (f_{θ})
2. One training pass of the proxy network (ĥ_{ϕ})

Generative network training is illustrated in the example of FIG. 2(a). Note that the generative and proxy network have separate optimizers, opt_{f}_{_{θ}}, opt_{ĥ}_{_{ϕ}}, respectively. This ensures parameter updates are performed individually for each network. Optimizer opt_{f}_{_{θ}} must minimise the loss in eq. 1.2.

$$ℒ ( \hat{y} , y , x , \hat{x} ) = {ℒ}_{gen} ( \hat{y} , y , x , \hat{x} ) \qquad ( 1.2 )$$

For the case of proxy network optimization, note that in the example of FIG. 2(b) gradients do not flow through the generative network (f_{θ}). The optimizer opt_{ĥ}_{_{ϕ}}, must minimise the loss in eq. 1.3.

$$ℒ ( \hat{y} , y ) = {ℒ}_{proxy} ( \hat{y} , y ) \qquad ( 1.3 )$$

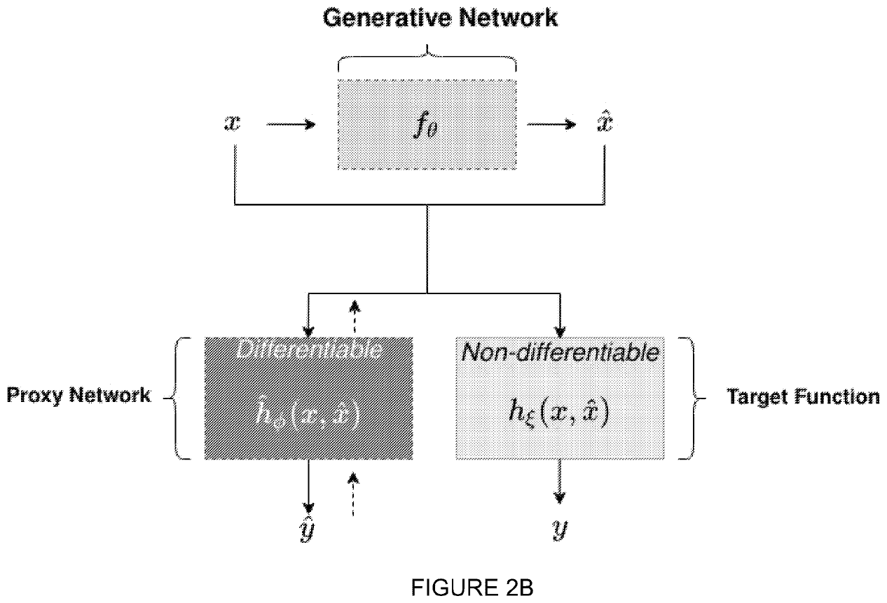

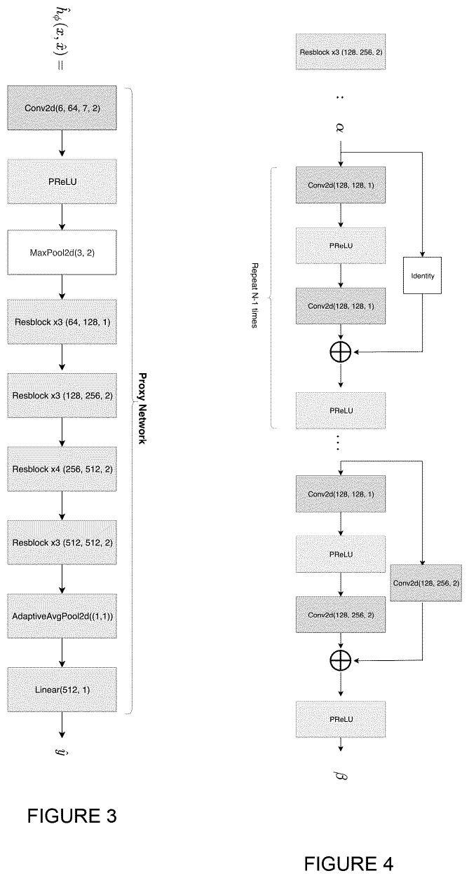

As a concrete example for color images, the proxy network ĥ_{ϕ} may be expressed as a collection of residual blocks as shown in the example of FIG. 3, where an example of a resblock structure can be seen in the example of FIG. 4. In this case, x, \hat{x} ∈ [symbol] ³ and ŷ ∈ [symbol] ¹. And [symbol] _{proxy}(ŷ, y) may be computed as [symbol] _{y} (∥ŷ−y∥ⁿ) for some n. This scenario will be discussed further in the next section.

A generic training algorithm example based on the outlined methodology below is shown in example algorithm 1.1.

Algorithm 1.1 Example pseudocode that outlines the training of
the generator and the proxy network. It assumes the
existence of 3 functions backpropagate and step and nogradients.
backpropagate uses backpropagation to
compute gradients of all parameters with respect to the loss.
step performs an optimization step with the selected
optimizer. The function nogradients ensures no gradients
are tracked for the function executed. The function
nogradients refers to how deep learning frameworks such as
PyTorch and Tensorflow V2 construct a computational
graph that is used for the back-propagation operation.
This means that producing \hat{x} with or without gradients impacts
whether or not ƒ_{θ} will be part of the computational graph, and
therefore whether or not gradients can flow through
the generator component. Therefore whether \hat{x} is produced
from ƒ_{θ}, with or without gradients matters, for the
back-propagation and optimizer update step.
Inputs:
Generator Network: ƒ_{θ}
Generator Optimizer: opt_{ƒ}_{_{θ}}
Proxy Network: ĥ_{ϕ}
Proxy Network Optimizer: op [symbol]
Loss for Proxy: [symbol]
Loss for Generator: [symbol] _{ƒ}_{_{θ}}
Target Function: h_{ξ}
Input tensor: x
Proxy Training:
\hat{x} ← nogradients(ƒ_{θ}(x))
ŷ ← ĥ_{ϕ}(x, \hat{x})
y ← h_{ξ}(x, \hat{x})
backpropagate( [symbol] (ŷ, y))
step (op [symbol] )
Generator Training:
\hat{x} ← ƒ_{θ}(x)
ŷ ← ĥ_{ϕ}(x, \hat{x})
backpropagate( [symbol] _{ƒ}_{_{θ}}(\hat{x}, x, ŷ))
step(opt_{ƒ}_{_{θ}})

### 1.2.2 Perceptual Loss Function Learning

Within the field of learned image compression, the generic method of learning a proxy to a GIF have natural extensions to perceptual loss functions. A perceptual loss function is a loss function that incorporates a perceptual metric, i.e. given the question “how good does this image look”, a useful perceptual metric aligns closely to the subjective human experience. This may more formally be referred to as a perceptual similarity metric. Such metrics may be GIFs (gradient intractable functions) since the notion of a perceptual metric may in itself be intractable.

The proxy method outlined above within the field of learned image and video compression allows networks to train with non-differentiable perceptual metrics. In addition, certain stability measures are also presented here to improve the learning process and achieve better results.

In place of the generic generative network f_{θ} seen in e.g. FIG. 1, the example of FIG. 5 shows a generic auto-encoder network with a bitstream of the latent variables. This scenario is a simplified view of learned compression, where in addition, the proxy network is now approximating some type of non-differentiable perceptual metric. Gradient flow, parameter updates and use of loss equations is equivalent to what has been shown in the examples of FIGS. 2a and 2b, it will not be restated.

In particular, a perceptual metric that was approximated in a manner as shown in the example of FIG. 5 is the Video Multimethod Assessment Fusion (VMAF), however the method may be applied to any non-differentiable function. In this case h_{ζ} is the ground truth VMAF and ĥ_{ϕ} is the learnt VMAF proxy that allows the generative network to be trained as if h_{ζ} was differentiable. An example of adversarial samples learnt by the generative network f_{θ} for the case where h_{ζ} is VMAF is shown in the example of FIG. 6.

For the case of learning perceptual metrics, where the proxy network ĥ_{ϕ} is part of the loss of the compression network, the training is typically highly unstable. In the next subsections methods are discussed that stabilises the training or reduce the onset of compression artifacts from the perceptual metric.

### Regularisation

At the start of the training procedure of the generative network or a compression network, shown as an autoencoder in the example of FIG. 5, the perceptual proxy network is typically highly unstable because the initial images predicted by the generative model are very poor. To help kickstart the training, another term is added to the total loss of the compression network to stabilise the initial training of the compression network.

Equation 1.2 for the generative loss, is a particular case of the loss function shown in eq. 1.1, which may be broken down into two distinct parts where D(x,\hat{x}) is a generic distortion loss that may include a number of different stabilisation terms, for example Mean Squared Error (MSE) or a combination of such analytical losses with weighted deep-embeddings of a pre-trained neural network; λ is a balance factor that may be kept constant or adjusted as the generative network trains

$${ℒ}_{f θ} ( x , \hat{x} , y ) = {ℒ}_{gen} ( x , \hat{x} , y , \hat{y} ) = D ( x , \hat{x} ) + {λℒ}_{perceptual} ( \hat{y} , y ) \qquad ( 1.4 )$$

where [symbol] _{perceptual} is some type of distance metric, such as e.g. an l^{N} norm. The example Algorithm 1.1 exemplifies the case of applying a regularisation where [symbol] _{f}_{_{θ}} in this case takes on the form shown in eq. 1.4.

### Multiscale Extension

The proxy network that approximates the non-differentiable perceptual target metric may learn to generalize better if it is provided with the same set of images at different scales. This is because the receptive field will cover a larger portion of the image for a downsampled input image, therefore it appears more robust against adversarial samples in addition to being more robust against artifact generation. Multiscale training is shown in the example of FIG. 8. A perceptual quality score is assigned to the image at each scale and is aggregated by some additional function agg(x), for example agg(x)= [symbol] ₓ(x). The multiscale extension is exemplified with pseudo-code in the example algorithm 1.2.

A user is able to select any number of scales to use. As an example, we could downsample the image at hand xᵢ by a factor of 2 and then a factor of 4 in each dimension to create

$${x}_{i \frac{1}{2}}$$

and

$${x}_{i \frac{1}{4}} .$$

As demonstrated in the example of FIG. 8 we may then use the generator network to evaluate

$${\hat{x}}_{i \frac{1}{2}}$$

and

$${\hat{x}}_{i \frac{1}{4}}$$

and \hat{x}ᵢ. Subsequently,

$${\hat{y}}_{i \frac{1}{2}} ,$$

$${\hat{y}}_{i \frac{1}{4}} ,$$

ŷᵢ and

$${y}_{i \frac{1}{2}} , {y}_{i \frac{1}{4}} ,$$

ŷᵢ are evaluated using the proxy network and the perceptual metric respectively. In an example, the mean of

$${\hat{y}}_{i \frac{1}{2}} , {\hat{y}}_{i \frac{1}{4}} ,$$

ŷᵢ is used to train the generator by attempting to maximise or minimise their average using stochastic gradient descent. The predictions

$${y}_{i \frac{1}{2}} , {y}_{i \frac{1}{4}} ,$$

ŷᵢ are used to train the proxy network to force its predictions to be closer to output of the perceptual metric, also using stochastic gradient descent.

Algorithm 1.2 Example pseudocode that outlines the training
of the generator and the proxy network. It
assumes the existence of 3 functions backpropagate
and step and nogradients. backpropagate uses
backpropagation to compute gradients of all parameters
with respect to the loss, and successive calls
accumulate gradients. step performs an optimization
step with the selected optimizer. The function
nogradients ensures no gradients are tracked for the function
executed. The function nogradients refers to
how deep learning frameworks such as PyTorch and
Tensorflow V2 construct a computational graph that is
used for the back-propagation operation. This means that
producing \hat{x} with or without gradients impacts
whether or not ƒ_{θ} will be part of the computational graph, and
therefore whether or not gradients can flow
through the generator component. Therefore whether \hat{x} is
produced from ƒ_{θ}, with or without gradients
matters, for the back-propagation and optimizer update step.
Inputs:
Generator Network: ƒ_{θ}
Generator Optimizer: opt_{ƒ}_{_{θ}}
Proxy Network: ĥ_{ϕ}
Proxy Network Optimizer: op [symbol]
Target Function: h_{ξ}
Loss for Proxy: [symbol]
Loss for Generator: [symbol] _{ƒ}_{_{θ}}
Loss Array for Proxy: [symbol]
Loss Array for Generator: L_{ƒ}_{_{θ}}
Aggregator Function: Agg
Input image at n different scales: X = {x₁, .., xₙ}
Proxy Training:
for x in X do

| | |
|---|---|
| \| | \hat{x} ← nogradients(ƒ_{θ}(x) |
| \| | ŷ ← ĥ_{ϕ}(x, \hat{x}) |
| \| | y ← h_{ξ}(x, \hat{x}) |
| \| | [symbol] ← [symbol] (ŷ, y) |
| \| | |

end
backpropagate(Agg( [symbol] ))
step(op [symbol] ))
Generator Training:
for x in X do

| | |
|---|---|
| \| | \hat{x} ← ƒ_{θ}(x) |
| \| | ŷ ← ĥ_{ϕ}(x, \hat{x}) |
| \| | L_{ƒ}_{_{θ}} ← [symbol] _{ƒ}_{_{θ}}(\hat{x}, x, ŷ) |
| \| | |

end
backpropagate (Agg(L_{ƒ}_{_{θ}}))
step(opt_{ƒ}_{_{θ}})

### 1.2.3 Adversarial Robustness

Regardless of the target function h_{ζ} that is approximated by the proxy network ĥ_{ϕ} it is possible the generative network f_{θ} will find a blind spot in the learnt approximation of the target function, or the target function may itself possess blind spots that allow the generative network to learn blind spot predictions. “Blind spots” refer to areas within the traversed loss surface found by the generative network that produce a low loss for the target function, but that for some reason are undesirable. For the case of a perceptual metric, there may be particular pixel artifacts that the generative network learns that achieves low losses, yet to a human observer are regarded as artifacts and a cause of image degradation. In the previous sections, two methods were briefly discussed to alleviate this issue and improve adversarial robustness. These were within the scope of perceptual metrics, but may be extended to arbitrary metrics.

Firstly, the addition of regularisation terms to the loss to avoid blind spot samples is considered. Regularisation may be achieved with any generic function that penalises the generative network when predicting adversarial samples, such as pixel wise error for perceptual proxy losses. Adding this regularisation loss term acts as a deterrent for the generative model, and steers it away from finding a basin on the loss surface which satisfies the proxy and the target function, but are clearly blind spot samples (e.g. determined by the practitioner). Whereas without the regularisation term, the proxy can achieve a low total loss while producing adversarial samples, adding the regularizer ensures the total loss term is high, forcing the model to find another basin to settle in. Therefore, a requirement of this regularisation term is that it should produce high loss values for adversarial images. These regularisation functions can be found by evaluating existing functions on a set of adversarial samples, and selecting one which produces the highest loss term.

Mitigation of blind spot samples may also be directly targeted by specifically training the proxy on such samples with self imposed labels to force the network components to avoid the blind spot boundaries in the loss surface. Such training may be conducted in a few different ways.

Adversarial samples may be collected, either from a model that is known to produce adversarial samples or synthetically generated by an algorithm, hand designed by humans, which adds noise or artefacts that resemble the artefacts seen on adversarial samples. This stored set of adversarial images are assigned a label such that the label conveys to the proxy that it is an undesired sample. Usually, during the proxy training, we get the input images from the generative model and the labels from the loss function we are trying to make differentiable. It is possible to not only use this mapping as the training set for the proxy, but also the set of adversarial samples stored, along with artificial labels assigned to train the proxy too. This training methodology can have numerous configurations, for instance, we could train the proxy once on the adversarial sample for every twenty samples from the generative model. A requirement of this method is that our stored adversarial set is exhaustive and contains enough adversarial samples such that the proxy is able to generalize over the domain of adversarial samples. An example of this method is demonstrated in the example of FIG. 9.

In addition, an online method of generating these adversarial samples is shown in the example of FIG. 10. In this method there exists a network configuration that only generates adversarial samples during its training by default, due to some model miss-specification. This network, referred to as the blind spot network, produces adversarial samples for our proxy function and therefore helps to define the underlying non-differentiable function we are trying to learn. We use this blind spot network to generate adversarial samples to train the proxy against. As can be immediately seen, this method is similar to the one described in the paragraph above and shown in the example of FIG. 9, however, the difference being that we do not store a set of adversarial samples, but generate them in an online fashion using the blind-spot network, which is also learning. An advantage of this network is that the adversarial samples generated will cover a wider set of adversarial noise, which will allow the proxy to generalize over the domain of all possible adversarial noise.

The blindspot method is exemplified in algorithmic form in example algorithm 1.3.

A simple example of this is as follows. Assume a network configuration A that is composed of a generative model and a proxy network, where the generative model of A produces adversarial samples only. To make A adversarially robust, two instantiations of A are used: one referred to as the blind spot network B. and the other, the network for which blindspots should be removed. A. During training, samples from the generator B will be drawn, self labelled, and used to correct A, forcing A away from the basin of adversarial samples. The example of FIG. 10 demonstrates an example of this method. The generator and proxy of B are also trained from randomly initialised parameters during this method. As can be seen, there are now two proxy networks, one which belongs to B used to train the generator of B, which we sample to get adversarial samples to correct A. The other proxy belong to A and it is the one being corrected by being fed adversarial samples from the generator of B with self-imposed labels. In the example of FIG. 10, the proxy of the blind spot network has been omitted for simplicity.

A corollary of this method is that it can be used to make any arbitrary function that has a blind spot, adversarially robust by approximating it as a proxy network.

Algorithm 1.3 Example pseudocode that outlines the training
of the generator and the proxy network. It
assumes the existence of 3 functions backpropagate and
step and nogradients. backpropagate uses
backpropagation to compute gradients of all parameters
with respect to the loss. step performs an
optimization step with the selected optimizer. The function
nogradients ensures no gradients are tracked for
the function executed. The function nogradients refers to how
deep learning frameworks such as PyTorch
and Tensorflow V2 construct a computational graph that is
used for the back-propagation operation. This
means that producing \hat{x} with or without gradients impacts
whether or not ƒ_{θ} will be part of the computational
graph, and therefore whether of not gradients can
flow through the generator component. Therefore whether
\hat{x} is produced from ƒ_{θ}, with or without gradients matters,
for the back-propagation and optimizer update step.
Inputs:
Generator Network: ƒ_{θ}
Generator Optimizer: opt_{ƒ}_{_{θ}}
Proxy Network: ĥ_{ϕ}
Proxy Network Optimizer: op [symbol]
Blindspot Network: b_{α}
Blindspot Optimizer: opt_{b}_{_{α}}
Blindspot Proxy Network: [symbol] _{ϕ}
Blindspot Proxy Network Optimizer: op [symbol]
Blindspot Label Function: B
Loss for Proxy: [symbol]
Loss for Blindspot Network: [symbol]
Loss for Blindspot Proxy Network: [symbol]
Loss for Generator: [symbol] _{ƒ}_{_{θ}}
Target Function: h_{ξ}
Input tensor: x
Blindspot Network Training:
\tilde{x} ← b_{α}(x)
\tilde{y} ← [symbol] _{ϕ}(x, \tilde{x})
y ← h_{ξ}(x, \tilde{x})
backpropagate( [symbol] _{b}_{_{α}} (\tilde{y}, y))
step(op [symbol] )
Proxy Training:
\hat{x} ← nogradients(ƒ_{θ}(x))
ŷ ← ĥ_{ϕ}(x, \hat{x})
y ← h_{ξ}(x, \hat{x})
backpropagate( [symbol] (ŷ, y))
step(op [symbol] )
Proxy Blindspot Training:
\tilde{x} ← nogradients(b_{α}(x))
\tilde{y} ← [symbol] _{ϕ}(x, \tilde{x})
y ← B( )
backpropagate( [symbol] (\tilde{y}, y))
step(op [symbol] )
Generator Training:
\hat{x} ← ƒ_{θ}(x)
ŷ ← \hat{ĥ}_{ϕ}(x, \hat{x})
backpropagate ( [symbol] _{ƒ}_{_{θ}}(\hat{x}, x, ŷ))
step(opt_{ƒ}_{_{θ}})

1. A method of training one or more neural networks, the one or more neural networks being for use in lossy image or video encoding, transmission and decoding, the method comprising the steps of:
receiving an input image at a first computer system;
encoding the input image using a first neural network to produce a latent representation;
decoding the latent representation using a second neural network to produce an output image, wherein the output image is an approximation of the input image;
wherein the method further comprises a step of generating an output using a trained differentiable proxy network, where the differentiable proxy network is configured to approximate a target function;
evaluating a function based on the output of the differentiable proxy network;
updating the parameters of the differentiable proxy network based on the evaluated function; and
repeating the above steps using a set of input images to produce a trained differentiable proxy network.

2. The method of claim 1, further comprising the steps of, after obtaining the trained differentiable proxy network:
receiving a further input image at a first computer system;
encoding the further input image using a first neural network to produce a latent representation;
decoding the latent representation using a second neural network to produce an further output image, wherein the further output image is an approximation of the further input image;
evaluating a function based on a difference between the further output image and the further input image;
updating the parameters of the first neural network and the second neural network based on the evaluated function; and
repeating the above steps using a further set of input images to produce a first trained neural network and a second trained neural network.

3. The method of claim 1, wherein the function is additionally based on a difference between the output image and the input image; and
the parameters of the first neural network and the second neural network are additionally updated based on the evaluated function to obtain a first trained neural network and a second trained neural network.

4. The method of claim 1, wherein the target function is a gradient intractable function.

5. The method of claim 1, wherein the input to the differentiable proxy network is the input image and the output image.

6. The method of claim 1, wherein the target function is a perceptual metric.

7. The method of claim 1, wherein the target function is a runtime device proxy.

8. The method of claim 1, wherein the output of the trained differentiable proxy network is used to obtain the output image.

9. The method of claim 1, wherein the target function is a quantization function.

10. The method of claim 1, wherein the input to the trained differentiable proxy network is the latent representation.

11. The method of claim 1, wherein the target function is a rounding function.

12. A method for lossy image or video encoding, transmission and decoding, the method comprising the steps of:
receiving an input image at a first computer system;
encoding the input image using a first trained neural network to produce a latent representation;
transmitting the latent representation to a second computer system; and
decoding the latent representation using a second trained neural network to produce an output image, wherein the output image is an approximation of the input image;
wherein the method further comprises a step of generating an output using a trained differentiable proxy network, where the trained differentiable proxy network is configured to approximate a target function.

13. The method of claim 12, wherein the target function is a gradient intractable function.

14. The method of claim 12, wherein the output of the trained differentiable proxy network is used to obtain the output image.

15. The method of claim 12, wherein the target function is a quantization function.

16. The method of claim 12, wherein the input to the trained differentiable proxy network is the latent representation.

17. The method of claim 12, wherein the target function is a rounding function.

18. A data processing system configured to perform the method of claim 1.
